(19) United States
(12) Patent Application Publication
(10) Pub. No.: US 2026/0371392 A1
(43) Pub. Date: Nov. 19, 2026

(54) COMMUNICATION METHOD AND COMMUNICATION APPARATUS

(71) Applicant: HUAWEI TECHNOLOGIES CO., LTD., Shenzhen (CN)

(72) Inventors: Gerile NAREN, Shenzhen (CN); Mengshi HU, Shenzhen (CN); Rui DU, Singapore (SG); Yunbo LI, Shenzhen (CN)

(21) Appl. No.: 19/336,713

(22) Filed: Sep. 23, 2025

Related U.S. Application Data
(63) Continuation of application No. PCT/CN2024/078869, filed on Feb. 28, 2024.

(30) Foreign Application Priority Data
Mar. 24, 2023 (CN) 202310327500.5

(51) Int. Cl. H04W 74/0816; H04W 74/06; H04W 84/12

(52) U.S. Cl. CPC H04W 74/0816; H04W 74/06; H04W 84/12

(57) ABSTRACT

The solution may be applied to a WLAN system that supports 802.11 series protocols such as a next-generation Wi-Fi protocol of IEEE 802.11ax like 802.11be, Wi-Fi 7, or EHT, a next-generation protocol of 802.11be like Wi-Fi 8, or the like; and may be further applied to a UWB-based wireless personal area network system and a sensing system, for example, the 802.11bf protocol A station may transmit, to an access point, a first frame used to request an SP in which DMG sensing measurement is performed, so that the access point determines, based on the first frame, that the station needs to perform DMG sensing measurement. This helps the access point allocate, to the station based on a requirement of the station, the SP in which DMG sensing measurement is performed, thereby helping meet a sensing measurement requirement of the station.

### CROSS-REFERENCE TO RELATED APPLICATIONS

This application is a continuation of International Application No. PCT/CN2024/078869, filed on Feb. 28, 2024, which claims priority to Chinese Patent Application No. 202310327500.5, filed on Mar. 24, 2023. The disclosures of the aforementioned applications are hereby incorporated by reference in their entireties.

### TECHNICAL FIELD

This disclosure relates to the communication field, and more specifically, to a communication method and a communication apparatus.

### BACKGROUND

A signal transmitted by a wireless fidelity (Wi-Fi) system device is usually received by another device after being reflected, diffracted, and scattered by various obstacles. Therefore, a signal received by the another device is usually obtained by superimposing a plurality of signals. This facilitates sensing, by using a radio signal, a physical environment through which the radio signal passes, and a sensing technology is derived accordingly.

A sensing initiator may be an access point (AP) or a personal basic service set control point (PCP), or may be a non-access point or personal basic service set control point station (non-AP/PCP STA). In a directional multi-gigabit (DMG) sensing scenario, a channel allocation manner in a beacon interval (BI) is determined by the AP/PCP. Therefore, when the sensing initiator is the non-AP/PCP STA, the non-AP/PCP STA needs to determine a sensing scheduling parameter based on a channel allocation parameter set by the AP/PCP in a current BI, to initiate a DMG sensing measurement setup procedure to a sensing responder. In this case, because the channel allocation parameter is not determined by the sensing initiator, channel resources allocated to the sensing initiator and channel resources allocated to the sensing responder may not meet a sensing measurement requirement of the non-AP/PCP STA.

In addition, when the sensing initiator is the AP/PCP, a channel allocated by the AP/PCP to a non-AP/PCP STA may not meet the sensing measurement requirement of the non-AP/PCP STA.

### SUMMARY

This disclosure provides a communication method and a communication apparatus, to meet a sensing measurement requirement of a non-AP/PCP STA.

According to a first aspect, a communication method is provided. The method may be performed by a communication device, or may be performed by a component (for example, a chip or a circuit) of a communication device. This is not limited. For ease of description, the following uses an example in which the method is performed by a station for description.

The method includes: The station transmits a first frame to an access point in a first beacon interval (BI), where the first frame is used to request a service period (SP) in which directional multi-gigabit (DMG) sensing measurement is performed; and the station receives a second frame from the access point in the first BI, where the second frame is a response frame of the first frame.

The access point is a DMG access point (AP) or a DMG personal basic service set control point (PCP), and the station is a non-access point or personal basic service set control point DMG station (non-AP/PCP DMG STA).

In this embodiment of this disclosure, the station transmits, to the access point, the first frame used to request the SP in which DMG sensing measurement is performed, so that the access point determines, based on the first frame, that the station needs to perform DMG sensing measurement. This helps the access point allocate, to the station based on the requirement of the station, the SP in which DMG sensing measurement is performed, thereby helping meet the sensing measurement requirement of the station.

For example, if the station is a sensing initiator of DMG sensing measurement, because the SP allocated by the access point to the station is allocated based on a request of the station, a sensing scheduling parameter determined by the station based on a channel allocation parameter in the BI may meet the sensing measurement requirement of the station.

For example, the sensing initiator of DMG sensing measurement is the station or the access point. In other words, DMG sensing measurement is initiated by the station or the access point. It may be understood that, if DMG sensing measurement is initiated by the station, the station initiates a DMG sensing measurement procedure by transmitting a DMG sensing measurement setup request frame; or if DMG sensing measurement is initiated by the access point, the access point initiates a DMG sensing measurement procedure by transmitting a DMG sensing measurement setup request frame.

For example, a sensing by proxy initiator of DMG sensing measurement is the station or the access point. In other words, DMG sensing measurement is DMG sensing by proxy measurement initiated by the station or the access point. It may be understood that, if DMG sensing measurement is DMG sensing by proxy measurement initiated by the station, the station initiates a DMG sensing by proxy measurement procedure by transmitting a DMG sensing by proxy (SBP) request frame; or if DMG sensing measurement is DMG sensing by proxy measurement initiated by the access point, the access point initiates a DMG sensing by proxy measurement procedure by transmitting a DMG SBP request frame.

With reference to the first aspect, in some implementations of the first aspect, the first frame includes first information, and the first information indicates whether DMG sensing measurement is applied in the first BI.

Based on the foregoing technical solution, the first frame transmitted by the station to the access point includes the first information, so that the access point can determine, based on the first information, whether DMG sensing measurement is applied in the first BI. Further, if DMG sensing measurement is applied in the first BI, the access point may allocate an SP in a first BI to the station, so that the station can perform DMG sensing measurement in the first BI in time, to meet a time validity requirement of the station for DMG sensing measurement.

For example, the first information is carried in a DMG allocation information field in a DMG traffic specification (TSPEC) element included in the first frame. For example, the first information is carried in one or more of a B11 field, a B12 field, a B13 field, a B14 field, and a B31 field in the DMG allocation information field.

With reference to the first aspect, in some implementations of the first aspect, the first frame includes second information, and the second information indicates a maximum interval between two consecutive that are requested by the station and in which DMG sensing measurement is performed.

Based on the foregoing technical solution, the access point may allocate, to the station based on the second information, SPs with a time interval between the two consecutive SPs falling within a specific range, to meet sensing measurement requirements of the station in some scenarios. For example, if the station needs to perform DMG sensing measurement to obtain consecutive capture of a target action or posture or consecutive tracking of a target location, a time interval between two consecutive times of DMG sensing measurement performed by the station cannot be excessively large. In this case, the station may transmit the first frame including the second information to the access point, so that the access point allocates, to the station, an SP that can meet a sensing measurement requirement of the station.

For example, the second information is carried in the DMG TSPEC element included in the first frame.

With reference to the first aspect, in some implementations of the first aspect, the first frame includes third information, the third information indicates whether the access point transmits a poll frame to the station before the access point allocates, to the station, the first SP in which DMG sensing measurement is performed, and the first SP is in the first BI.

Based on the foregoing technical solution, if the first frame includes the third information, and the third information indicates that the access point does not transmit the poll frame to the station, the access point may allocate the first SP to the station based on the first frame, thereby reducing a signaling procedure. If the first frame includes the third information, and the third information indicates that the access point transmits the poll frame to the station, after the station receives the poll frame from the access point, the station may transmit a service period request (SPR) frame to the access point, to update a parameter of the SP (for example, shortest duration of the SP) that is requested by the station and in which DMG sensing measurement is performed. Therefore, this disclosure is applicable to a scenario in which a sensing measurement requirement of the station changes.

For example, the third information is carried in the DMG allocation information field in the DMG TSPEC element included in the first frame. For example, the third information is carried in one or more of the B11 field, the B12 field, the B13 field, the B14 field, and the B31 field in the DMG allocation information field.

With reference to the first aspect, in some implementations of the first aspect, after the station receives the second frame from the access point, the method further includes: The station receives a grant frame from the access point in the first BI, where the grant frame is used to allocate, to the station, the first SP in which DMG sensing measurement is performed, and the first SP is in the first BI.

Based on the foregoing technical solution, the access point may allocate, to the station, the first SP in the first BI by transmitting the grant frame to the station, so that the station can perform DMG sensing measurement in the first SP. This helps meet a time validity requirement of the station for DMG sensing measurement.

With reference to the first aspect, in some implementations of the first aspect, the first frame includes a first allocation identifier, and the first allocation identifier corresponds to the SP in which DMG sensing measurement is performed; and the grant frame includes a second allocation identifier, the second allocation identifier corresponds to the SP in which DMG sensing measurement is performed, the second allocation identifier is the same as the first allocation identifier, and the second allocation identifier is carried in a B0 field to a B3 field in a dynamic allocation information field included in the grant frame.

Based on the foregoing technical solution, if the station may perform a plurality of different times of DMG sensing measurement, after receiving the grant frame, the station may determine, when determining that the second allocation identifier included in the grant frame is the same as the first allocation identifier, DMG sensing measurement corresponding to the first SP allocated by using the grant frame.

With reference to the first aspect, in some implementations of the first aspect, before the station receives the grant frame from the access point in the first BI, the method further includes: The station receives the poll frame from the access point in the first BI; and the station transmits, to the access point, a service period request frame in the first BI based on the poll frame, where the service period request frame is used to request the SP in which DMG sensing measurement is performed in the first BI, and the grant frame is transmitted by the access point based on the service period request frame.

Based on the foregoing technical solution, after receiving the poll frame from the access point, the station may transmit the service period request frame to the access point, to update a parameter of an SP (for example, shortest duration of the SP) that are requested by the station and in which DMG sensing measurement is performed. Therefore, this disclosure is applicable to a scenario in which a sensing measurement requirement of the station changes.

With reference to the first aspect, in some implementations of the first aspect, the first frame includes the first allocation identifier, and the first allocation identifier corresponds to the SP in which DMG sensing measurement is performed; the grant frame includes the second allocation identifier, the second allocation identifier corresponds to the SP in which DMG sensing measurement is performed, the second allocation identifier is the same as the first allocation identifier, and the second allocation identifier is carried in the B0 field to the B3 field in the dynamic allocation information field included in the grant frame; and the service period request frame includes a third allocation identifier, the third allocation identifier corresponds to the SP in which DMG sensing measurement is performed, the third allocation identifier is the same as the first allocation identifier and the second allocation identifier, and the third allocation identifier is carried in a B0 field to a B3 field in a dynamic allocation information field included in the service period request frame.

Based on the foregoing technical solution, if the station requests a plurality of SPs of different DMG sensing measurement, after receiving the service period request frame, the station may determine, when determining that the third allocation identifier included in the service period request frame is the same as the first allocation identifier, DMG sensing measurement corresponding to the SP requested by using the service period request frame. Correspondingly, after receiving the grant frame, the station may determine, when determining that the second allocation identifier included in the grant frame is the same as the first allocation identifier, DMG sensing measurement corresponding to the first SP allocated by using the grant frame.

With reference to the first aspect, in some implementations of the first aspect, the method further includes: The station receives a third frame from the access point in a second BI, where the second BI is after the first BI, the third frame is used to allocate, to the station, a second SP in which DMG sensing measurement is performed in the second BI, a source association identifier AID corresponding to the second SP identifies the sensing initiator of DMG sensing measurement, and a destination AID corresponding to the second SP identifies a sensing responder of DMG sensing measurement.

Based on the foregoing technical solution, the access point may allocate, to the station, an SP in the second BI based on a request of the station, so that the station performs DMG sensing measurement in the second BI. This helps meet a DMG sensing measurement requirement of the station.

For example, DMG sensing measurement is monostatic sensing measurement performed by the station, and the sensing initiator of DMG sensing measurement and the sensing responder of DMG sensing measurement are the station. In this case, the source AID corresponding to the second SP is the same as the destination AID corresponding to the second SP.

For example, the SP that are requested by the station and in which DMG sensing measurement is performed is an aperiodic SP.

With reference to the first aspect, in some implementations of the first aspect, the first frame includes the first allocation identifier, and the first allocation identifier corresponds to the SP in which DMG sensing measurement is performed; and the third frame includes a fourth allocation identifier, the fourth allocation identifier corresponds to the SP in which DMG sensing measurement is performed, and the fourth allocation identifier is the same as the first allocation identifier.

Based on the foregoing technical solution, if the station may perform a plurality of different times of DMG sensing measurement, after receiving the third frame, the station may determine, when determining that the second allocation identifier included in the third frame is the same as the first allocation identifier, DMG sensing measurement corresponding to the second SP allocated by using the third frame.

With reference to the first aspect, in some implementations of the first aspect, the first frame is a DMG sensing measurement setup request frame, the first frame is further used to configure a sensing measurement parameter used to perform DMG sensing measurement, the second frame is a DMG sensing measurement setup response frame, and the second frame indicates that the access point supports allocating, to the station, the SP in which DMG sensing measurement is performed, and indicates whether the access point supports the sensing measurement parameter; or the first frame is a DMG sensing by proxy request frame, the first frame is further used to configure a sensing measurement parameter used to perform DMG sensing measurement and a parameter related to a sensing by proxy procedure, the second frame is a DMG sensing by proxy response frame, and the second frame indicates that the access point supports allocating, to the station, the SP in which DMG sensing measurement is performed, and indicates whether the access point supports the sensing measurement parameter and/or the parameter related to the sensing by proxy procedure.

With reference to the first aspect, in some implementations of the first aspect, the first frame is a DMG sensing measurement setup request frame, the first frame is further used to configure a sensing measurement parameter used to perform DMG sensing measurement, the second frame is a DMG sensing measurement setup response frame, and the second frame indicates that the access point does not support allocating, to the station, the SP in which DMG sensing measurement is performed, and indicates whether the access point supports the sensing measurement parameter; or the first frame is a DMG sensing by proxy request frame, the first frame is further used to configure a sensing measurement parameter used to perform DMG sensing measurement and a parameter related to a sensing by proxy procedure, the second frame is a DMG sensing by proxy response frame, and the second frame indicates that the access point does not support allocating, to the station, the SP in which DMG sensing measurement is performed, and indicates whether the access point supports the sensing measurement parameter and the parameter related to the sensing by proxy procedure.

According to a second aspect, a communication method is provided. The method may be performed by a communication device, or may be performed by a component (for example, a chip or a circuit) of a communication device. This is not limited. For ease of description, the following uses an example in which the method is performed by an access point for description.

The method includes: The access point receives a first frame from a station in a first BI, where the first frame is used to request an SP in which DMG sensing measurement is performed; and the access point transmits a second frame to the station in the first BI, where the second frame is a response frame of the first frame.

For beneficial effect of the second aspect and implementations of the second aspect, refer to descriptions of the first aspect.

With reference to the second aspect, in some implementations of the second aspect, a sensing initiator of DMG sensing measurement is the station or the access point.

With reference to the second aspect, in some implementations of the second aspect, the first frame includes first information, and the first information indicates whether DMG sensing measurement is applied in the first BI.

With reference to the second aspect, in some implementations of the second aspect, the first information is carried in a DMG allocation information field in a DMG TSPEC element included in the first frame.

With reference to the second aspect, in some implementations of the second aspect, the first frame includes second information, and the second information indicates a maximum interval between two consecutive SPs that are requested by the station and in which DMG sensing measurement is performed.

With reference to the second aspect, in some implementations of the second aspect, the second information is carried in the DMG TSPEC element included in the first frame.

With reference to the second aspect, in some implementations of the second aspect, the first frame includes third information, the third information indicates whether the access point transmits a poll frame to the station before the access point allocates, to the station, a first SP in which DMG sensing measurement is performed, and the first SP is in the first BI.

With reference to the second aspect, in some implementations of the second aspect, the third information is carried in the DMG allocation information field in the DMG TSPEC element included in the first frame.

With reference to the second aspect, in some implementations of the second aspect, after the access point transmits the second frame to the station, the method further includes: The access point transmits a grant frame to the station in the first BI, where the grant frame is used to allocate, to the station, the first SP in which DMG sensing measurement is performed, and the first SP is in the first BI.

With reference to the second aspect, in some implementations of the second aspect, the first frame includes a first allocation identifier, and the first allocation identifier corresponds to the SP in which DMG sensing measurement is performed; and the grant frame includes a second allocation identifier, the second allocation identifier corresponds to the SP in which DMG sensing measurement is performed, the second allocation identifier is the same as the first allocation identifier, and the second allocation identifier is carried in a B0 field to a B3 field in a dynamic allocation information field included in the grant frame.

With reference to the second aspect, in some implementations of the second aspect, before the access point transmits the grant frame to the station in the first BI, the method further includes: The access point transmits the poll frame to the station in the first BI; and the access point receives a service period request frame from the station in the first BI, where the service period request frame is used to request the SP in which DMG sensing measurement is performed in the first BI, and the grant frame is transmitted by the access point based on the service period request frame.

With reference to the second aspect, in some implementations of the second aspect, the first frame includes a first allocation identifier, and the first allocation identifier corresponds to the SP in which DMG sensing measurement is performed; the grant frame includes a second allocation identifier, the second allocation identifier corresponds to the SP in which DMG sensing measurement is performed, the second allocation identifier is the same as the first allocation identifier, and the second allocation identifier is carried in the B0 field to the B3 field in the dynamic allocation information field included in the grant frame; and the service period request frame includes a third allocation identifier, the third allocation identifier corresponds to the SP in which DMG sensing measurement is performed, the third allocation identifier is the same as the first allocation identifier and the second allocation identifier, and the third allocation identifier is carried in a B0 field to a B3 field in a dynamic allocation information field included in the service period request frame.

With reference to the second aspect, in some implementations of the second aspect, the method further includes: The access point transmits a third frame to the station in a second BI, where the second BI is after the first BI, the third frame is used to allocate, to the station, a second SP in which DMG sensing measurement is performed in the second BI, a source AID corresponding to the second SP identifies the sensing initiator of DMG sensing measurement, and a destination AID corresponding to the second SP identifies a sensing responder of DMG sensing measurement.

With reference to the second aspect, in some implementations of the second aspect, DMG sensing measurement is monostatic sensing measurement performed by the station, and the sensing initiator of DMG sensing measurement and the sensing responder of DMG sensing measurement are the station.

With reference to the second aspect, in some implementations of the second aspect, the SP that are requested by the station and in which DMG sensing measurement is performed is an aperiodic SP.

With reference to the second aspect, in some implementations of the second aspect, the first frame includes the first allocation identifier, and the first allocation identifier corresponds to the SP in which DMG sensing measurement is performed; and the third frame includes a fourth allocation identifier, the fourth allocation identifier corresponds to the SP in which DMG sensing measurement is performed, and the fourth allocation identifier is the same as the first allocation identifier.

With reference to the second aspect, in some implementations of the second aspect, the first frame is a DMG sensing measurement setup request frame, the first frame is further used to configure a sensing measurement parameter used to perform DMG sensing measurement, the second frame is a DMG sensing measurement setup response frame, and the second frame indicates that the access point supports allocating, to the station, the SP in which DMG sensing measurement is performed, and indicates whether the access point supports the sensing measurement parameter; or the first frame is a DMG sensing by proxy request frame, the first frame is further used to configure a sensing measurement parameter used to perform DMG sensing measurement and a parameter related to a sensing by proxy procedure, the second frame is a DMG sensing by proxy response frame, and the second frame indicates that the access point supports allocating, to the station, the SP in which DMG sensing measurement is performed, and indicates whether the access point supports the sensing measurement parameter and/or the parameter related to the sensing by proxy procedure.

With reference to the second aspect, in some implementations of the second aspect, the first frame is a DMG sensing measurement setup request frame, the first frame is further used to configure a sensing measurement parameter used to perform DMG sensing measurement, the second frame is a DMG sensing measurement setup response frame, and the second frame indicates that the access point does not support allocating, to the station, the SP in which DMG sensing measurement is performed, and indicates whether the access point supports the sensing measurement parameter; or the first frame is a DMG sensing by proxy request frame, the first frame is further used to configure a sensing measurement parameter used to perform DMG sensing measurement and a parameter related to a sensing by proxy procedure, the second frame is a DMG sensing by proxy response frame, and the second frame indicates that the access point does not support allocating, to the station, the SP in which DMG sensing measurement is performed, and indicates whether the access point supports the sensing measurement parameter and the parameter related to the sensing by proxy procedure.

According to a third aspect, a communication apparatus is provided. The communication apparatus is configured to perform the method according to either the first aspect or the second aspect. Specifically, the communication apparatus may include units and/or modules configured to perform the method according to any one of the first aspect or the implementations of the first aspect, or include units and/or modules configured to perform the method according to any one of the second aspect or the implementations of the second aspect, for example, a processing unit and/or a transceiver unit.

In an implementation, the communication apparatus is a device (for example, a station or an access point). When the communication apparatus is the device, the transceiver unit may be a transceiver or an input/output interface, and the processing unit may be at least one processor. Optionally, the transceiver may be a transceiver circuit. Optionally, the input/output interface may be an input/output circuit.

In another implementation, the communication apparatus is a chip, a chip system, or a circuit used in a device (for example, a station, or an access point). When the communication apparatus is the chip, the chip system, or the circuit used in the device, the transceiver unit may be an input/output interface, an interface circuit, an output circuit, an input circuit, a pin, a related circuit, or the like in the chip, the chip system, or the circuit; and the processing unit may be at least one processor, a processing circuit, a logic circuit, or the like.

According to a fourth aspect, a communication apparatus is provided. The apparatus includes: a memory, configured to store a program; and at least one processor, configured to execute a computer program or instructions stored in the memory, to perform the method according to any one of the first aspect or the implementations of the first aspect, or perform the method according to any one of the second aspect or the implementations of the second aspect.

In an implementation, the communication apparatus is a device (for example, a station or an access point).

In another implementation, the apparatus is a chip, a chip system, or a circuit used in a device (for example, a station, or an access point).

According to a fifth aspect, this disclosure provides a processor, configured to perform the method according to the foregoing aspects.

Operations such as transmitting and obtaining/receiving related to the processor may be understood as operations such as outputting, receiving, and inputting performed by the processor, or operations such as transmitting and receiving performed by a radio frequency circuit and an antenna, unless otherwise specified, or provided that the operations do not conflict with actual functions or internal logic of the operations in related descriptions. This is not limited in this disclosure.

According to a sixth aspect, a computer-readable storage medium is provided. The computer-readable storage medium stores program code to be executed by a device, and the program code includes instructions for performing the method according to any one of the first aspect or the implementations of the first aspect, or includes instructions for performing the method according to any one of the second aspect or the implementations of the second aspect.

According to a seventh aspect, a computer program product including instructions is provided. When the computer program product runs on a computer, the computer is enabled to perform the method according to any one of the first aspect or the implementations of the first aspect, or the computer is enabled to perform the method according to any one of the second aspect or the implementations of the second aspect.

According to an eighth aspect, a chip is provided. The chip includes a processor and a communication interface. The processor reads, through the communication interface, instructions stored in a memory, to perform the method according to any one of the first aspect or the implementations of the first aspect, or perform the method according to any one of the second aspect or the implementations of the second aspect.

Optionally, in an implementation, the chip further includes the memory. The memory stores a computer program or the instructions. The processor is configured to execute the computer program or the instructions stored in the memory. When the computer program or the instructions are executed, the processor is configured to perform the method according to any one of the first aspect or the implementations of the first aspect, or perform the method according to any one of the second aspect or the implementations of the second aspect.

According to a ninth aspect, a communication system is provided, including the foregoing station and access point.

### BRIEF DESCRIPTION OF DRAWINGS

FIG. 1 is a diagram of an application scenario to which embodiments of this disclosure are applicable;

FIGS. 2(a)-2(h) shows five types of high-frequency sensing;

FIG. 3 is a diagram of a structure of a BI;

FIG. 4 is a schematic flowchart of a method according to an embodiment of this disclosure;

FIG. 5 is a diagram of a method according to an embodiment of this disclosure;

FIG. 6 is a diagram of a structure of a first element according to an embodiment of this disclosure;

FIG. 7 is a diagram of a structure of a DMG allocation information field according to an embodiment of this disclosure;

FIG. 8 is a diagram of another structure of a first element according to an embodiment of this disclosure;

FIG. 9 is a diagram of another structure of a DMG allocation information field according to an embodiment of this disclosure;

FIG. 10 is a schematic flowchart of a method according to an embodiment of this disclosure;

FIG. 11 is a diagram of a structure of a service period request frame;

FIG. 12 is a diagram of a method according to an embodiment of this disclosure;

FIG. 13 is a schematic flowchart of a method according to an embodiment of this disclosure;

FIG. 14 is a diagram of a structure of an extended schedule element;

FIG. 15 is a diagram of a method according to an embodiment of this disclosure;

FIG. 16 is a diagram of a communication apparatus according to an embodiment of this disclosure;

FIG. 17 is a diagram of another communication apparatus according to an embodiment of this disclosure; and

FIG. 18 is a diagram of a chip system according to an embodiment of this disclosure.

### DESCRIPTION OF EMBODIMENTS

Technical solutions provided in embodiments of this disclosure are applicable to a wireless local area network (WLAN) scenario, for example, may be applicable to the IEEE 802.11 system standards such as the 802.11a/b/g standard, the 802.11bf standard, the 802.11ad standard, and the 802.11ay standard, or may be applicable to a next-generation standard. 802.11bf includes two major standards: a low frequency (sub-7 GHz) standard and a high frequency (60 GHz) standard. An implementation of the sub-7 GHz standard mainly relies on standards such as 802.11ac, 802.11ax, 802.11be, and a next-generation standard, and an implementation of the 60 GHz standard mainly relies on standards such as 802.11ad, 802.11ay, and a next-generation standard. 802.11ad may also be referred to as a directional multi-gigabit (DMG) standard. 802.11ay may also be referred to as an enhanced directional multi-gigabit (EDMG) standard. The technical solutions in embodiments of this disclosure mainly focus on implementation of 802.11bf in a high frequency (802.11ad and 802.11ay), but a related technical principle may be extended to standards in a low frequency (802.11ac, 802.11ax, and 802.11be).

Although embodiments of this disclosure are mainly described by using an example in which a WLAN network is deployed, especially a network to which the IEEE 802.11 system standard is applied, a person skilled in the art easily understands that aspects in embodiments of this disclosure may be extended to other networks using various standards or protocols, for example, Bluetooth, a high performance radio local area network (HIPERLAN), a wide area network (WAN), a personal area network (PAN), or another network that is currently known or developed in the future. Therefore, regardless of a used coverage area and a used wireless access protocol, various aspects provided in embodiments of this disclosure are applicable to any suitable wireless network.

The technical solutions of embodiments of this disclosure may be further applied to various communication systems, such as a WLAN communication system, a wireless fidelity (Wi-Fi) system, a global system for mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (, TDD) system, a universal mobile telecommunication system (UMTS), a worldwide interoperability for microwave access (WiMAX) communication system, a 5th generation (5G) system or a new radio (NR) system, a future 6th generation (6G) system, or a wireless local area network system like an internet of things (IoT) network or a vehicle-to-everything (V2X) network.

The foregoing communication systems applicable to this disclosure are only examples for description, and communication systems applicable to this disclosure are not limited thereto. This is uniformly described herein, and details are not described below again.

The following describes the technical solutions in embodiments of this disclosure with reference to accompanying drawings in embodiments of this disclosure. In descriptions of this disclosure, unless otherwise specified, “/” represents an “or” relationship between associated objects. For example, A/B may represent A or B. In this disclosure, “and/or” describes only an association relationship between associated objects and represents that three relationships may exist. For example, A and/or B may represent the following three cases: Only A exists, both A and B exist, and only B exists, where A or B may be singular or plural. In addition, in descriptions of this disclosure, “a plurality of” means two or more than two unless otherwise specified. “At least one of the following items (pieces)” or a similar expression thereof means any combination of these items, including a single item (piece) or any combination of plural items (pieces). For example, at least one item (piece) of a, b, or c may represent: a, b, c, a and b, a and c, b and c, or a, b, and c, where a, b, and c may be singular or plural. In addition, to clearly describe the technical solutions in embodiments of this disclosure, terms such as “first” and “second” are used in embodiments of this disclosure to distinguish between same items or similar items that provide basically same functions or purposes. A person skilled in the art may understand that the words “first” and “second” do not limit a quantity and an execution sequence, and the words “first” and “second” do not indicate a definite difference. In addition, in embodiments of this disclosure, terms such as “example” or “for example” are used to give an example, an illustration, or a description. Any embodiment or design scheme described as an “example” or “for example” in embodiments of this disclosure should not be construed as being more preferred or more advantageous than another embodiment or design scheme. Exactly, use of the terms such as “example” or “for example” is intended to present a related concept in a specific manner for ease of understanding.

In addition, a network architecture and a service scenario described in embodiments of this disclosure are intended to describe the technical solutions in embodiments of this disclosure more clearly, and do not constitute a limitation on the technical solutions provided in embodiments of this disclosure. A person of ordinary skill in the art may be aware that, with evolution of the network architecture and emergence of new service scenarios, the technical solutions provided in embodiments of this disclosure are also applicable to similar technical problems.

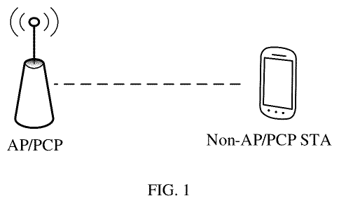

FIG. 1 is a diagram of an application scenario to which embodiments of this disclosure are applicable. As shown in FIG. 1, the method provided in this disclosure is applicable to communication between stations (STA). The station may be an access point (AP) or a personal basic service set control point (PCP), or may be a non-access point or personal basic service set control point station (non-AP/PCP STA).

The AP/PCP may be an access point through which a terminal (such as a mobile phone) accesses a wired (or wireless) network, is mainly deployed in a home, a building, and a campus, and has a typical coverage radius of tens of meters to hundreds of meters. Certainly, the AP/PCP may alternatively be deployed outdoors. The AP/PCP serves as a bridge between the wired network and the wireless network, and has main functions of connecting various wireless network clients together and then connecting the wireless network to the Ethernet.

Specifically, the AP/PCP may be a terminal or a network device with a Wi-Fi chip, and the network device may be a server, a router, a switch, a bridge, a computer, a mobile phone, a relay station, a vehicle-mounted device, a wearable device, a network device in a 5G network, a network device in a future 6G network, a network device in a public land mobile communication network (PLMN), or the like. This is not limited in embodiments of this disclosure. The AP/PCP may be a device that supports a Wi-Fi standard. For example, the AP/PCP may support one or more standards of the 802.11 family of the Institute of Electrical and Electronics Engineers (IEEE), such as 802.11a, 802.11b, 802.11g, 802.11n, 802.11ac, 802.11ax, 802.11be, 802.11bf, 802.11ad, and 802.11ay.

The non-AP/PCP STA may be a wireless communication chip, a wireless sensor, a wireless communication terminal, or the like, and may also be referred to as a user, user equipment (UE), an access terminal, a subscriber unit, a subscriber station, a mobile station, a mobile console, a remote station, a remote terminal, a mobile device, a user terminal, a terminal, a wireless communication device, a user agent, or a user apparatus. The non-AP/PCP STA may also be a cellular phone, a cordless phone, a session initiation protocol (SIP) phone, a wireless local loop (WLL) station, a personal digital assistant (PDA), a handheld device with a wireless communication function, a computing device or another processing device connected to a wireless modem, a vehicle-mounted device, an internet of things device, a wearable device, a terminal device in a 5G network, a terminal device in a future 6G network, a terminal device in a PLMN, or the like. This is not limited in embodiments of this disclosure. The non-AP/PCP STA may be a device that supports a WLAN standard. For example, the non-AP station may support one or more standards of the IEEE 802.11 family, such as 802.11a, 802.11b, 802.11g, 802.11n, 802.11ac, 802.11ax, 802.11be, 802.11bf, 802.11ad, and 802.11ay.

For example, the non-AP/PCP STA may be a mobile phone, a tablet computer, a set-top box, a smart television, an intelligent wearable device, a vehicle-mounted communication device, a computer, an internet of things (IoT) node, a sensor, or a smart home, such as a smart camera, a smart remote control, a smart water meter, a smart electricity meter, and a sensor in a smart city.

The AP/PCP or the non-AP/PCP STA may include a transmitter, a receiver, a memory, a processor, and the like. The transmitter and the receiver are respectively configured to transmit and receive a packet structure. The memory is configured to: store signaling information, store a preset value agreed in advance, and the like. The processor is configured to: parse the signaling information, process related data, and the like.

Radar sensing is a Wi-Fi sensing technology. A radar includes a transmit antenna and a receive antenna. The transmit antenna transmits an electromagnetic wave, the electromagnetic wave is reflected when encountering a target, and a reflected wave may be received by the receive antenna. A radar system analyzes feature information of the target, such as a location, a shape, a motion feature, and a motion track, through signal processing based on changes of a transmitted wave and a received wave. Radar sensing has many unique advantages. For example, the radar is not affected by lighting conditions, and has a capability of penetrating obstacles, so that personal privacy can be better protected. In addition, the radar has a farther sensing range, and does not cause harm to people or animals. An advantage of implementing sensing by using the radar technology is mainly reflected in motion detection. A motion status of the target, for example, a motion direction and a motion speed, is observed and interpreted based on a doppler effect of an echo of the target.

Introducing the sensing technology into the WLAN has a good commercial prospect. The Wi-Fi sensing technology may be applied in different scenarios. For example, in sports, this technology may be used to detect motion statuses and motion tracks of a person and a ball. For another example, in a home environment, this technology may be used to perform human body fall detection, to prevent an elderly person from falling. The Wi-Fi sensing technology can fully utilize existing WLAN resources without massive costs. In a future densely deployed WLAN, there may be a plurality of non-AP STAs within coverage of one AP, and the AP may perform proper resource scheduling for each non-AP STA, to improve a system throughput, robustness, and the like.

The 802.11bf protocol supports sensing in a sub-7 GHz frequency band and a high frequency band (for example, 60 GHz). In the sub-7 GHz frequency band, sensing is used to detect a wireless channel and estimate channel state information (CSI), to identify an action, track a motion track, and detect falling. In the 60 GHz frequency band, sensing is used to perform directional beam sweeping on an environment to obtain a range doppler map (RD Map), to obtain state information of the target and environment information. A phase of a transmit antenna is adjusted, so that energy of radio signals is aggregated in a specific direction, to form a directivity (or directional) beam. A directional beam has a narrow beam width and more concentrated energy. Therefore, the directional beam has a higher antenna gain and causes less interference to another received signal.

The following briefly describes some concepts in embodiments of this disclosure.

### 1. Roles in Sensing

A WLAN sensing technology may include the following roles. It should be understood that in some scenarios, the following different roles may be performed by a same device.
(1) A sensing initiator is a non-DMG station that initiates a WLAN sensing procedure by transmitting a sensing measurement setup request frame, or a DMG station that initiates a DMG sensing procedure by transmitting a DMG sensing measurement setup request frame.

Sensing initiator: A non-directional multi-gigabit (non-DMG) station (STA) that initiates a wireless local area network (WLAN) sensing procedure by transmitting a sensing measurement setup request frame, or a DMG STA that initiates a DMG sensing procedure by transmitting a DMG sensing measurement setup request frame.
(2) A sensing responder is a non-DMG STA that participates in a WLAN sensing procedure by responding to a sensing initiator, or a DMG station that participates in a DMG sensing procedure by responding to a sensing initiator.

Sensing responder: A non-directional multi-gigabit (non-DMG) station (STA) that participates in a wireless local area network (WLAN) sensing procedure by responding to a sensing initiator, or a DMG STA that participates in a DMG sensing procedure responding to a sensing initiator.
(3) A sensing transmitter is a station that transmits physical layer protocol data units (PPDU) used for sensing measurement in a WLAN sensing procedure or a DMG sensing procedure.

Sensing transmitter: A station (STA) that transmits PPDUs used for measurements in a wireless local area network (WLAN) sensing procedure or a directional multi-gigabit (DMG) sensing procedure.
(4) A sensing receiver is a station that receives PPDUs transmitted by a sensing transmitter and obtains measurement results in a WLAN sensing procedure or a DMG sensing procedure.

Sensing receiver: A station (STA) that is the intended recipient of PPDUs sent by a sensing transmitter and obtains measurements in either a wireless local area network (WLAN) sensing procedure or a directional multi-gigabit (DMG) sensing procedure.

In sensing by proxy (SBP), roles in sensing further include:
(5) A sensing by proxy initiator (SBP initiator) is a non-access point (non-AP) or a non-DMG STA that transmits an SBP request frame, or a non-AP/PCP DMG STA that transmits a DMG SBP request frame.

Sensing by proxy (SBP) initiator: A non-access point (non-AP) non-directional multi-gigabit (non-DMG) station (STA) that transmits an SBP request frame, or a non-AP and non-personal basic service set (PBSS) control point (non-PCP) DMG STA that transmits a DMG SBP request frame.
(6) A sensing by proxy responder (SBP responder) is a non-DMG access point (non-DMG AP) that is an intended recipient of an SBP request frame, or a DMG AP or a DMG PCP that is an intended recipient of a DMG SBP request frame.

Sensing by proxy (SBP) responder: A non-directional multi-gigabit (non-DMG) access point (AP) that is the intended recipient of an SBP request frame, or a DMG AP or DMG personal basic service set (PBSS) control point (PCP) that is the intended recipient of a DMG SBP request frame.

### 2. DMG Sensing Procedure

DMG sensing may also be referred to as high-frequency sensing. The DMG sensing procedure may include the following several steps:
(1) DMG sensing session setup: A sensing initiator and a sensing responder exchange DMG sensing capability information.
(2) DMG sensing measurement setup: The sensing initiator and the sensing responder negotiate a DMG sensing measurement parameter, for example, a beam configuration parameter and sensing measurement scheduling information. In the DMG sensing measurement setup procedure, the sensing initiator may transmit a DMG sensing measurement setup request frame to the sensing responder, and the sensing responder may transmit a DMG sensing measurement setup response (DMG sensing measurement setup response) frame to the sensing initiator.
(3) DMG sensing measurement instance group (DMG sensing burst): Consecutive DMG sensing measurement instances occur in the DMG sensing measurement instance group.
(4) DMG sensing measurement instance (DMG sensing instance): DMG sensing measurement occurs in the DMG sensing measurement instance.
(5) DMG sensing measurement report: The sensing responder feeds back a DMG sensing measurement report to the sensing initiator.
(6) DMG sensing measurement setup termination: A DMG sensing measurement setup is terminated (a group of parameters is no longer used to perform DMG sensing measurement).
(7) DMG sensing session termination: A DMG sensing session is terminated (DMG sensing measurement is no longer performed).

### 3. Types of High-Frequency Sensing

In the protocol, five types of high-frequency sensing are specified: monostatic sensing, bistatic sensing, multistatic sensing, monostatic sensing with coordination, and bistatic sensing with coordination.

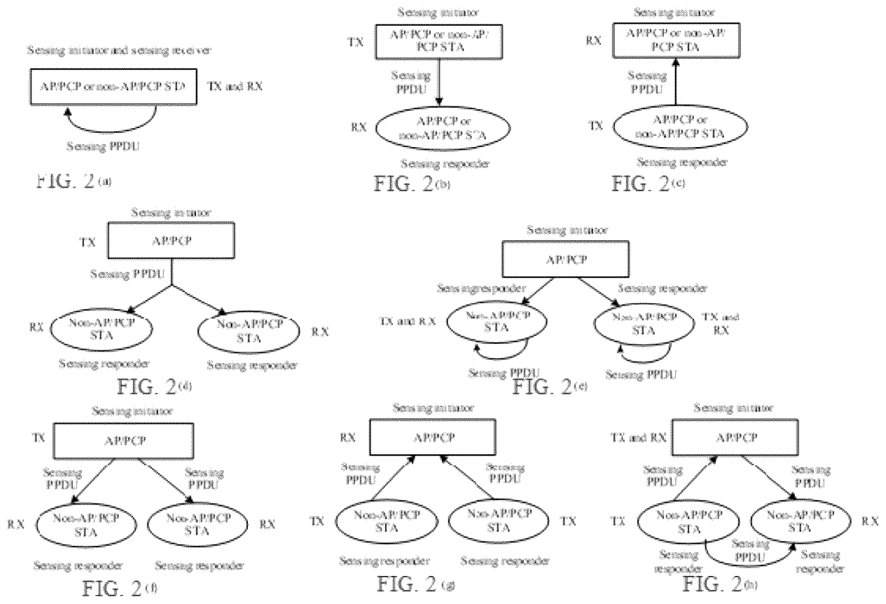

FIGS. 2(a)-2(h) shows the foregoing five types of high-frequency sensing. High-frequency sensing means DMG sensing or EDMG sensing defined in the IEEE 802.11bf protocol. High-frequency sensing in which a transmitter and a receiver are a same device may be referred to as self-transmitting and self-receiving. High-frequency sensing in which a transmitter and a receiver are different devices may be referred to as transmit/receive separation. In FIGS. 2(a)-2(h), TX represents a sensing transmitter, and RX represents a sensing receiver.

FIG. 2(a) shows monostatic sensing. As shown in FIG. 2(a), in monostatic sensing, a sensing initiator serves as both a sensing transmitter and a sensing receiver, and receives a sensing PPDU transmitted by the sensing initiator to perform sensing measurement, that is, self-transmitting and self-receiving.

FIG. 2(b) and FIG. 2(c) show bistatic sensing. As shown in FIGS. 2(b) and 2(c), in bistatic sensing, a sensing initiator and a sensing responder respectively play roles of a sensing transmitter and a sensing receiver, that is, one transmitter and one receiver. The sensing transmitter transmits a sensing PPDU to the sensing receiver, and the sensing receiver performs sensing measurement. In FIG. 2(b), a sensing initiator serves as a sensing transmitter, and a sensing responder serves as a sensing receiver. In FIG. 2(c), a sensing initiator serves as a sensing receiver, and a sensing responder serves as a sensing transmitter.

FIG. 2(d) shows multistatic sensing. As shown in FIG. 2(d), in multistatic sensing, a sensing initiator serves as a sensing transmitter, and transmits one sensing PPDU to a plurality of sensing responders, that is, one transmitter and a plurality of receivers, and these sensing responders serve as sensing receivers to perform sensing measurement.

FIG. 2(e) shows monostatic sensing with coordination. As shown in FIG. 2(e), in monostatic sensing with coordination, a sensing initiator enables one or more sensing responders to perform self-transmitting and self-receiving sensing measurement.

FIG. 2(f), FIG. 2(g), and FIG. 2(h) show bistatic sensing with coordination. As shown in FIGS. 2(f), 2(g) and 2(h), in bistatic sensing with coordination, a sensing initiator performs “one transmitter and one receiver” sensing measurement with a plurality of sensing responders. In FIG. 2(f), a sensing initiator serves as a sensing transmitter, and a plurality of sensing responders respectively serve as sensing receivers. In FIG. 2(g), a sensing initiator serves as a sensing receiver, and a plurality of sensing responders respectively serve as sensing transmitters. In FIG. 2(h), one sensing responder serves as a sensing transmitter, and the other sensing responder serves as a sensing receiver. To be specific, the sensing responder serving as a TX transmits a sensing PPDU to the other sensing responder serving as an RX, and the other sensing responder serving as the RX performs sensing measurement, and then feeds back a measurement result to the sensing initiator. In addition, in FIG. 2(h), the sensing initiator is both the sensing transmitter and the sensing receiver. One sensing responder may transmit a sensing PPDU to the sensing initiator, and the sensing initiator may also transmit a sensing PPDU to the other sensing responder.

It can be learned from FIGS. 2(a)-2(h) that, in monostatic sensing and bistatic sensing, a sensing initiator may be an AP/PCP or a non-AP/PCP STA, and a sensing responder may also be an AP/PCP or a non-AP/PCP STA, while in multistatic sensing, monostatic sensing with coordination, and bistatic sensing with coordination, a sensing initiator is usually an AP/PCP, and a sensing responder is usually a non-AP/PCP STA.

### 4. Channel Access Method Applied to DMG Sensing

In the IEEE 802.11 series protocols, there are two DMG channel access manners: a contention-based access period (CBAP) and a service period (SP). In a DMG scenario, an AP/PCP declares or announces a manner in which a device in a network accesses a channel.

In the DMG scenario, a time axis is divided into beacon intervals (BI).

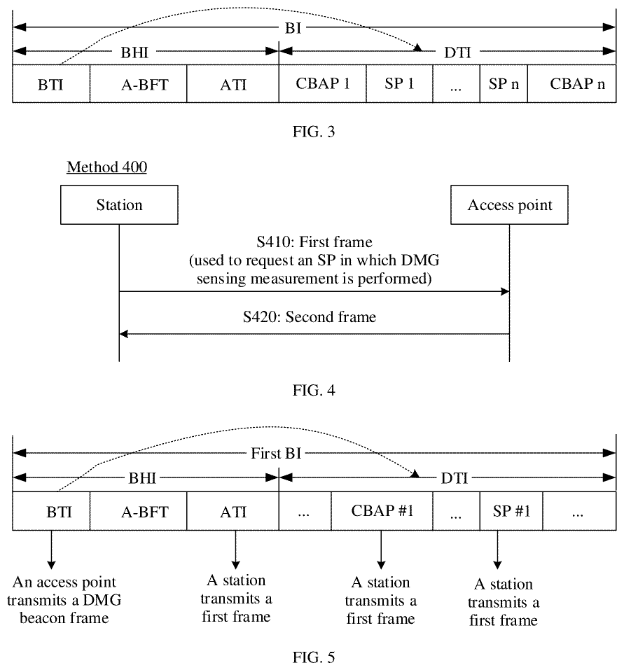

FIG. 3 is a diagram of a structure of a BI. Refer to FIG. 3. The BI includes a beacon header indication (BHI) and a data transmission interval (DTI). The BHI includes a beacon transmission interval (BTI), association-beamforming training (A-BFT), and an announcement transmission interval (ATI). The PCP/AP transmits one or more beacon frames in the BTI. One function of the beacon is to notify another device of a DTI channel access manner in the current BI. The A-BFT is used to perform beamforming training between STAs that receive the beacon frames. The ATI is used by the PCP/AP to poll the STAs for cached data information and allocate resources in the DTI to the STAs. The DTI includes several subintervals, and the several subintervals are divided into CBAPs (for example, a CBAP 1 and a CBAP n shown in FIG. 3) and SPs (for example, an SP 1 and an SP n shown in FIG. 3). The CBAP means that any device that wants to use a channel resource to transmit a signal needs to preempt a transmit opportunity (TXOP) through contention, and only a device that obtains the TXOP can use the channel resource to perform transmission. The SP means that a device can directly obtain a channel resource allocated by the AP/PCP for transmission.

Regardless of the CBAP or the SP, a source association identifier (source AID) and a destination association identifier (destination AID) need to be specified for each channel access, to indicate two devices to which the channel resource is allocated for communication. When the source AID and the destination AID respectively represent AIDs of a specific pair of devices, the CBAP or the SP is allocated to the pair of devices, and other devices cannot access or use the corresponding channel resource. The source AID and the destination AID may alternatively be set to broadcast AIDs, to indicate that any device may attempt to access the channel resource allocated to the CBAP or the SP.

Refer to the foregoing description in FIGS. 2(a)-2(h). A sensing initiator may be an AP/PCP, or may be a non-AP/PCP STA. When the sensing initiator is the AP/PCP, the AP/PCP transmits a DMG sensing measurement setup request frame to a sensing responder in one BI. The DMG sensing measurement setup request frame is used to configure a sensing measurement parameter and a sensing scheduling parameter (for example, a measurement frequency and a quantity of measurement repetitions). The sensing scheduling parameter needs to be set based on a channel allocation parameter in the BI. When the sensing initiator is the non-AP/PCP STA, the non-AP/PCP STA needs to determine a sensing scheduling parameter based on a channel allocation parameter set by the AP/PCP in the current BI, to initiate a DMG sensing measurement setup procedure to a sensing responder. In this case, because the channel allocation parameter is not determined by the sensing initiator, channel resources allocated to the sensing initiator and channel resources allocated to the sensing responder may not meet a sensing measurement requirement of the non-AP/PCP STA.

In addition, when the sensing initiator is the AP/PCP, a channel allocated by the AP/PCP to a non-AP/PCP STA may not meet a sensing measurement requirement of the non-AP/PCP STA.

In view of this, this disclosure provides a communication method, to meet a sensing measurement requirement of a non-AP/PCP STA serving as a sensing initiator.

It should be noted that a station mentioned in the following embodiments is a non-AP/PCP DMG STA, and an access point mentioned in the following embodiments is a DMG AP/PCP.

FIG. 4 is a schematic flowchart of a communication method according to an embodiment of this disclosure. As shown in FIG. 4, a method 400 may include the following steps:

S410: The station transmits a first frame to the access point.

Correspondingly, the access point receives the first frame from the station.

The first frame is used to request an SP in which DMG sensing measurement #1 is performed, or the first frame is used to request a channel allocation for performing DMG sensing measurement #1. The channel allocation for performing DMG sensing measurement #1 may include one or more SPs.

For example, a sensing initiator of DMG sensing measurement #1 is the station or the access point. In other words, DMG sensing measurement #1 is initiated by the station or the access point. It may be understood that if DMG sensing measurement #1 is initiated by the station, the station initiates a DMG sensing measurement procedure by transmitting a DMG sensing measurement setup request frame; or if DMG sensing measurement #1 is initiated by the access point, the access point initiates a DMG sensing measurement procedure by transmitting a DMG sensing measurement setup request frame. It should be understood that, if the sensing initiator of DMG sensing measurement #1 is the access point, a sensing responder of DMG sensing measurement #1 is the station.

For example, a sensing by proxy initiator of DMG sensing measurement #1 is the station or the access point. In other words, DMG sensing measurement #1 is DMG sensing by proxy measurement initiated by the station or the access point. It may be understood that, if DMG sensing measurement #1 is DMG sensing by proxy measurement initiated by the station, the station initiates a DMG sensing by proxy measurement procedure by transmitting a DMG SBP request frame. It should be understood that, if the sensing by proxy initiator of DMG sensing measurement #1 is the station, a sensing by proxy responder of DMG sensing measurement #1 is the access point; or if DMG sensing measurement #1 is initiated by the access point, the access point initiates a DMG sensing by proxy measurement procedure by transmitting a DMG SBP request frame. It should be understood that, if the sensing by proxy initiator of DMG sensing measurement #1 is the access point, a sensing by proxy responder of DMG sensing measurement #1 is the station or another access point; and if the sensing by proxy responder of DMG sensing measurement #1 is the another access point, a sensing responder of DMG sensing measurement #1 initiated by the another access point serving as the sensing by proxy responder is the station.

For example, the SP requested by the first frame is a periodic SP or an aperiodic SP. In other words, the channel allocation requested by using the first frame is a periodic channel allocation or an aperiodic channel allocation.

It should be noted that the SP or the channel allocation requested by using the first frame is mainly used to perform DMG sensing measurement #1, that is, DMG sensing measurement instances/bursts. For another sensing procedure corresponding to DMG sensing measurement #1, for example, a DMG sensing measurement #1 setup procedure, a channel access manner may not be limited. In other words, the another sensing procedure corresponding to DMG sensing measurement #1 may be performed in a CBAP or an SP.

For example, the station transmits the first frame to the access point in a first BI.

As shown in FIG. 5, the station may transmit the first frame to the access point in an ATI included in the first BI; or the station may transmit the first frame to the access point in a CBAP #1 in a DTI included in the first BI. It may be understood that when the station preempts a TXOP through contention in the CBAP #1, the station may transmit the first frame to the access point in the CBAP #1; or the station may transmit the first frame to the access point in an SP #1 in the DTI included in the first BI. It may be understood that when the access point allocates the SP #1 to the station, the station may transmit the first frame to the access point in the SP #1.

It should be noted that the DTI included in the first BI shown in FIG. 5 may further include another CBAP different from the CBAP #1, and/or include another SP different from the SP #1. It should be further noted that the access point may transmit a DMG beacon frame in a BTI in a BHI included in the first BI, so that the station may determine, based on the DMG beacon frame, types of subintervals in the DTI included in the first BI, and determine whether an SP in the DTI included in the first BI is an SP allocated to the station.

Optionally, the first frame includes information #1, and the information #1 indicates a parameter of an SP that are requested by the station and in which DMG sensing measurement is performed #1, or the information #1 indicates a parameter of the channel allocation that are requested by the station and in which DMG sensing measurement is performed #1. For example, the information #1 is carried in a first element included in the first frame.

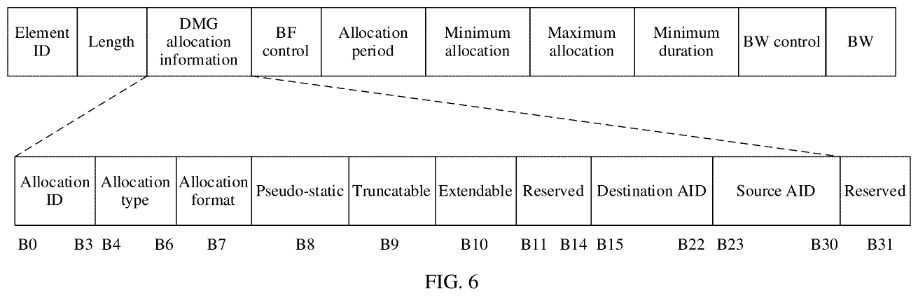

FIG. 6 is a diagram of a structure of the first element. As shown in FIG. 6, the first element may include the following fields: an element identifier (element ID) field that indicates an identifier of the first element; a length field that indicates a length of the first element; a DMG allocation information field; a beamforming (BF) control field that indicates control information related to beamforming; an allocation period field that indicates a period of the channel allocation that are requested by the station and in which DMG sensing measurement is performed #1; a minimum allocation field that indicates minimum channel allocation duration that can be accepted by the station in each period; a maximum allocation field that indicates channel allocation duration requested by the station in each period; a minimum duration field that indicates shortest duration of one SP that are requested by the station and in which DMG sensing measurement is performed #1; a bandwidth (BW) control (BW control) field that indicates bandwidth-related control information; and a BW field that indicates a bandwidth that are requested by the station and in which DMG sensing measurement is performed #1. A unit of the duration may be second(s), millisecond (ms), BI, or the like. This is not limited in this embodiment of this disclosure.

As shown in FIG. 6, the DMG allocation information field may include the following fields: an allocation identifier (allocation ID) field that indicates an identifier of the allocation requested by the station; an allocation type field that indicates a type of the allocation requested by the station, where when the field is set to “001”, it indicates that the station requests an SP in which DMG sensing measurement #1 is performed; an allocation format field that indicates whether the channel allocation requested by the station for DMG sensing measurement #1 is a periodic allocation or an aperiodic allocation; a pseudo-static field that indicates whether the allocation requested by the station is quasi-static; a truncatable field that indicates whether the allocation requested by the station is truncatable; an extendable field that indicates whether the allocation requested by the station is extendable; a destination AID field that indicates a sensing responder that performs DMG sensing measurement #1 in the SP requested by the station; a source AID field that indicates a sensing initiator that performs DMG sensing measurement #1 in the SP requested by the station; and a reserved field. If the allocation requested by the station is quasi-static, it indicates that start time of the allocation requested by the station in each BI is fixed relative to start time of the BI. The start time of the BI may be referred to as target beacon transmission time (TBTT).

Optionally, as shown in FIG. 6, the allocation identifier field is located in a B0 field to a B3 field in the DMG allocation information field, the allocation type field is located in a B4 field to a B6 field in the DMG allocation information field, the allocation format field is located in a B7 field in the DMG allocation information field, the pseudo-static field is located in a B8 field in the DMG allocation information field, the truncatable field is located in a B9 field in the DMG allocation information field, the extendable field is located in a B10 field in the DMG allocation information field, the destination AID field is located in a B15 field to a B22 field in the DMG allocation information field, the source AID field is located in a B23 field to a B30 field in the DMG allocation information field, and a B11 field to a B14 field and a B31 field in the DMG allocation information field are reserved fields.

For example, the first element may be named as a DMG traffic specification (TSPEC) element.

Based on the diagram of the structure of the first element shown in FIG. 6, the information #1 may be located in one or more of the following fields included in the first element: the allocation period field, the minimum allocation field, the maximum allocation field, the minimum duration field, and the DMG allocation information field.

Optionally, the first frame includes first information, and the first information indicates whether DMG sensing measurement #1 is applied in the first BI, the first information indicates whether the station requests an SP or a channel allocation in the first BI, or the first information indicates whether DMG sensing measurement #1 starts from the first BI. It should be understood that, if the first information indicates that DMG sensing measurement #1 is not applied in the first BI, it indicates that DMG sensing measurement #1 starts from a BI following the first BI. For example, DMG sensing measurement #1 starts from a next BI of the first BI.

As described above, the station may receive the DMG beacon frame from the access point in the BTI in the BHI included in the first BI, and determine, based on the DMG beacon frame, the types of the subintervals in the DTI included in the first BI. If the station determines, based on the DMG beacon frame, that the DTI included in the first BI includes a dynamic SP, the first frame transmitted by the station to the access point may include the first information, and the first information indicates that DMG sensing measurement #1 is applied in the first BI. If the station determines, based on the DMG beacon frame, that the DTI included in the first BI does not include a dynamic SP, the first frame transmitted by the station to the access point may not include the first information; or the first frame includes the first information, and the first information indicates that DMG sensing measurement #1 is not applied in the first BI. A source AID corresponding to the dynamic SP and a destination AID corresponding to the dynamic SP are broadcast AIDs.

For example, the first information is carried in the first element included in the first frame. For example, the first information is carried in a first field in the DMG allocation information field included in the first element.

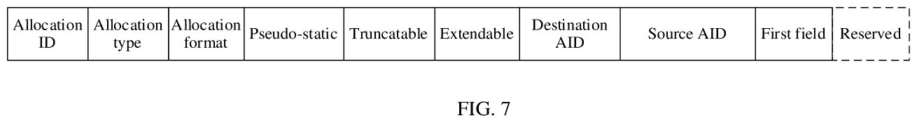

FIG. 7 is a diagram of another structure of the DMG allocation information field. As shown in FIG. 7, the DMG allocation information field may include the following fields: an allocation identifier field, an allocation type field, an allocation format field, a pseudo-static field, a truncatable field, an extendable field, a destination AID field, a source AID field, and a first field. Optionally, the DMG allocation information field shown in FIG. 7 may further include a reserved field.

Based on the diagram of the structure of the DMG allocation information field shown in FIG. 7, the first information may be carried in the first field. For example, if the first field occupies 1 bit field, when the first field is set to “1”, the first field indicates that DMG sensing measurement #1 is applied in the first BI, and when the first field is set to “0”, the first field indicates that DMG sensing measurement #1 is not applied in the first BI. For another example, if the first field occupies 1 bit field, when the first field is set to “0”, the first field indicates that DMG sensing measurement #1 is applied in the first BI, and when the first field is set to “1”, the first field indicates that DMG sensing measurement #1 is not applied in the first BI. The first field may alternatively occupy a plurality of bit fields. This is not limited in this embodiment of this disclosure.

For example, with reference to the diagram of the structure of the DMG allocation information field shown in FIG. 6, if the reserved fields included in the DMG allocation information field shown in FIG. 6 are located in the B11 field to the B14 field and the B31 field in the DMG allocation information field, the first field included in the DMG allocation information field shown in FIG. 7 may be located in one or more of the B11 field, the B12 field, the B13 field, the B14 field, and the B31 field in the DMG allocation information field. Optionally, if the first field included in the DMG allocation information field shown in FIG. 7 does not occupy all of the B11 field, the B12 field, the B13 field, the B14 field, and the B31 field, the DMG allocation information field may further include a reserved field. For example, if the first field occupies the B31 field in the DMG allocation information field, the B11 field to the B14 field in the DMG allocation information field are reserved fields.

For example, the first field may be named as an “immediate field”. It should be understood that a name of the first field is not limited in this embodiment of this disclosure, and the first field may alternatively have another name.

Optionally, the first frame includes second information. The second information indicates a maximum interval between two consecutive SPs that are requested by the station and in which DMG sensing measurement #1 is performed, or the second information indicates a maximum interval between two consecutive times of DMG sensing measurement corresponding to DMG sensing measurement #1, or the second information indicates a maximum interval between two consecutive channel allocations that are requested by the station and in which DMG sensing measurement is performed #1. The maximum interval between the two consecutive that are requested by the station and in which DMG sensing measurement is performed #1 may be in a unit of BI, second(s), millisecond (ms), or the like. This is not limited in this embodiment of this disclosure.

For example, the second information is carried in the first element included in the first frame.

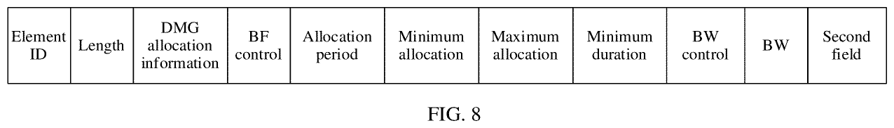

FIG. 8 is a diagram of another structure of the first element. As shown in FIG. 8, the first element may include the following fields: an element identifier field, a length field, a BF control field, an allocation period field, a minimum allocation field, a maximum allocation field, a minimum duration field, a BW control field, a BW field, and a second field.

Based on the diagram of the structure of the first element shown in FIG. 8, the second information may be carried in the second field. For example, the second field may be named as a “maximum interval between allocations field”. It should be understood that a name of the second field is not limited in this embodiment of this disclosure, and the second field may alternatively have another name.

For example, the second field occupies 2 bytes (bytes).

For example, the second field is located between the minimum duration field and the BW control field that are included in the first element. Alternatively, when the first element does not include the BF control field, the second field is located between a DMG allocation information field and the allocation period field that are included in the first element.

Optionally, the first frame includes third information, the third information indicates whether the access point transmits a poll frame to the station before the access point allocates, to the station, a first SP in which DMG sensing measurement #1 is performed, and the first SP is in the first BI.

As described above, the station may receive the DMG beacon frame from the access point in the BTI in the BHI included in the first BI, and determine, based on the beacon frame, the types of the subintervals in the DTI included in the first BI. If the station determines, based on the DMG beacon frame, that the DTI included in the first BI includes a dynamic SP, the first frame transmitted by the station to the access point may include the third information. For example, if the first frame includes the information #1, the first frame includes the third information, and the third information indicates that the access point does not transmit the poll frame to the station before the access point allocates the first SP to the station. For another example, when a parameter of the SP that is requested by the station and in which DMG sensing measurement #1 is performed (for example, shortest duration of the SP in which DMG sensing measurement #1 is performed) does not change at least before the first BI ends, the third information included in the first frame indicates that the access point does not transmit the poll frame to the station before the access point allocates the SP to the station. For another example, after transmitting the first frame, the station may update the parameter of the SP in which DMG sensing measurement #1 is performed (for example, shortest duration of the SP in which DMG sensing measurement #1 is performed). In this case, the third information included in the first frame indicates that the access point transmits the poll frame to the station before the access point allocates the SP to the station.

For example, the third information is carried in the first element included in the first frame. For example, the third information is carried in a third field in the DMG allocation information field included in the first element.

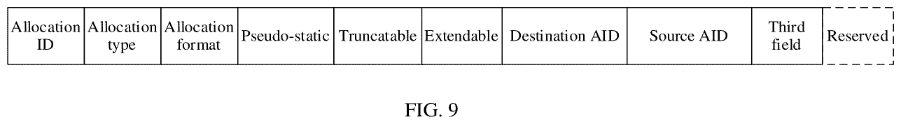

FIG. 9 is a diagram of another structure of the DMG allocation information field. As shown in FIG. 9, the DMG allocation information field may include the following fields: an allocation identifier field, an allocation type field, an allocation format field, a pseudo-static field, a truncatable field, an extendable field, a destination AID field, a source AID field, and the third field. Optionally, the DMG allocation information field shown in FIG. 9 may further include a reserved field.

Based on the diagram of the structure of the DMG allocation information field shown in FIG. 9, the third information may be carried in the third field. For example, if the third field occupies 1 bit field, when the third field is set to “1”, the third field indicates that the access point transmits the poll frame to the station before the access point allocates the first SP to the station, and when the first field is set to “0”, the third field indicates that the access point does not transmit the poll frame to the station before the access point allocates the first SP to the station. For another example, if the third field occupies 1 bit field, when the third field is set to “0”, the first field indicates that the access point transmits the poll frame to the station before the access point allocates the first SP to the station, and when the third field is set to “1”, the third field indicates that the access point does not transmit the poll frame to the station before the access point allocates the first SP to the station. The third field may alternatively occupy a plurality of bit fields. This is not limited in this embodiment of this disclosure.

For example, with reference to the diagram of the structure of the DMG allocation information field shown in FIG. 6, if the reserved fields included in the DMG allocation information field shown in FIG. 6 are located in the B11 field to the B14 field and the B31 field in the DMG allocation information field, the third field included in the DMG allocation information field shown in FIG. 9 may be located in one or more of the B11 field, the B12 field, the B13 field, the B14 field, and the B31 field in the DMG allocation information field. Optionally, if the third field included in the DMG allocation information field shown in FIG. 6 does not occupy all of the B11 field, the B12 field, the B13 field, the B14 field, and the B31 field, the DMG allocation information field may further include a reserved field. For example, if the third field occupies the B31 field in the DMG allocation information field, the B11 field to the B14 field in the DMG allocation information field are reserved fields.

For example, the third field may be named as a “poll field”. It should be understood that a name of the third field is not limited in this embodiment of this disclosure, and the third field may alternatively have another name.

It should be understood that, in S410, the first frame transmitted by the station to the access point may include one or more of the information #1, the first information, the second information, and the third information. This is not limited in this embodiment of this disclosure.

Optionally, the first frame includes a first allocation identifier, and the first allocation identifier corresponds to the SP in which DMG sensing measurement #1 is performed. For example, the first allocation identifier is carried in the allocation identifier field in the DMG allocation information field in the first element included in the first frame.

Optionally, the first frame is further used to request an SP in which DMG sensing measurement #2 is performed, and a sensing initiator of DMG sensing measurement #2 is the station or the access point. In other words, DMG sensing measurement #2 is initiated by the station or the access point. For example, the first frame may include one or more of information #2, information #3, information #4, or information #5. The information #2 indicates a parameter of the SP that are requested by the station and in which DMG sensing measurement is performed #2. For more descriptions of the information #2, refer to the foregoing descriptions of the information #1. The information #3 indicates whether DMG sensing measurement #2 is applied in the first BI. For more descriptions of the information #3, refer to the foregoing descriptions of the first information. The information #4 indicates a maximum interval between two consecutive that are requested by the station and in which DMG sensing measurement is performed #2. For more descriptions of the information #4, refer to the foregoing descriptions of the second information. The information #5 indicates whether the access point transmits the poll frame to the station before the access point allocates, to the station, a third SP in which DMG sensing measurement #2 is performed, and the third SP is in the first BI. For more descriptions of the information #5, refer to the foregoing descriptions of the third information.

Optionally, if the first frame is further used to request the SP in which DMG sensing measurement #2 is performed, the first frame may further include an allocation identifier #1, and the allocation identifier #1 corresponds to the SP in which DMG sensing measurement #2 is performed. For example, the allocation identifier #1 is carried in an allocation identifier field in a DMG allocation information field in a second element included in the first frame. For more descriptions of the second element, refer to the foregoing descriptions of the first element.

The first frame is not limited in this embodiment of this disclosure.

In a possible implementation, the first frame may be a DMG add traffic stream (ADDTS) request (DMG ADDTS request) frame.

In a possible implementation, the first frame may be a DMG sensing SP request frame. A DMG action field value corresponding to the DMG sensing SP request frame is (last assigned values (last assigned)+1) or (last assigned+2). “Last assigned” is a last value in DMG action field values defined in a current protocol. Optionally, a frame format of the DMG sensing SP request frame is shown in Table 1.

TABLE 1
Frame format of a DMG sensing SP request frame
Action field in the DMG sensing SP request frame

| Order | Information |
|---|---|
| 1 | Category |
| 2 | Action |
| 3 | Dialog token |
| 4 | DMG TSPEC element |

In a possible implementation, if the station is a sensing initiator of DMG sensing measurement, and the access point is a sensing responder of DMG sensing measurement, the first frame may be a DMG sensing measurement setup request frame. It may be understood that, when the first frame is the DMG sensing measurement setup request frame, the first frame may be further used to configure a DMG sensing measurement parameter used to perform DMG sensing measurement #1, for example, a beam configuration parameter or sensing measurement scheduling information.

In a possible implementation, if the station is a sensing by proxy initiator, and the access point is a sensing by proxy responder, the first frame may be a DMG SBP request frame. It may be understood that, when the first frame is the DMG SBP request frame, the first frame may be further used to configure a parameter related to a sensing by proxy procedure. The first frame may be further used to configure a DMG sensing measurement parameter.

S420: The access point transmits a second frame to the station.

Correspondingly, the station receives the second frame from the access point.

The second frame is a response frame of the first frame. When receiving the first frame from the station, the access point may transmit the second frame to the station based on the first frame.

In a possible implementation, after the access point receives the first frame from the station, if the access point can allocate, to the station, the SP in which DMG sensing measurement #1 is performed, the second frame transmitted by the access point to the station indicates that the access point supports allocating, to the station, the SP in which DMG sensing measurement is performed. For example, the second frame includes a status code, and the status code is set to “SUCCESS”, to indicate that the access point supports allocating, to the station, the SP in which DMG sensing measurement #1 is performed.

Optionally, when the access point may allocate, to the station, the SP in which DMG sensing measurement #1 is performed, the second frame may include information #6, and the information #6 indicates a parameter of the SP that is allocated by the access point to the station and in which DMG sensing measurement #1 is performed.

For example, the information #6 is carried in a third element included in the second frame. A structure of the third element is shown in FIG. 6 or FIG. 8. For more descriptions of the third element, refer to the foregoing descriptions of the first element. For example, the third element may be named as a DMG TSPEC element.

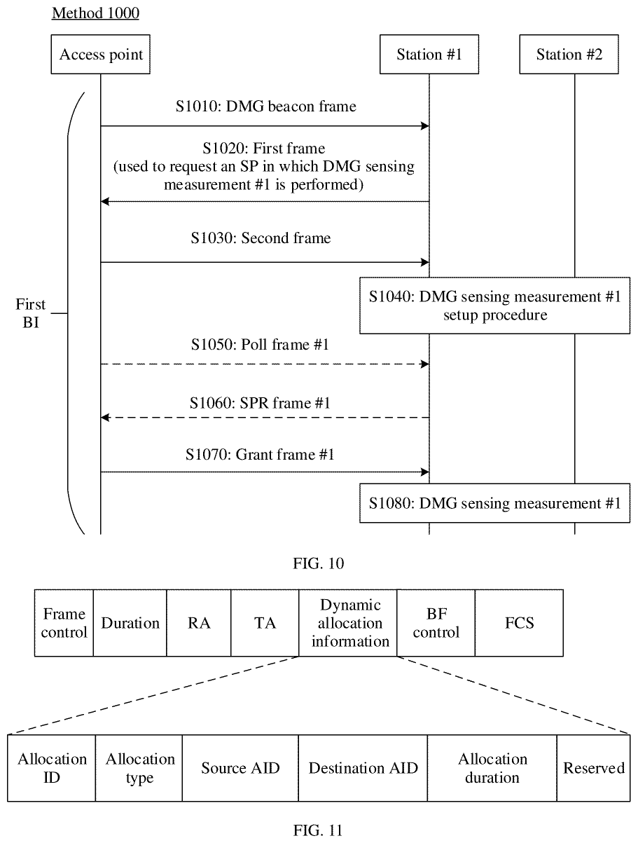

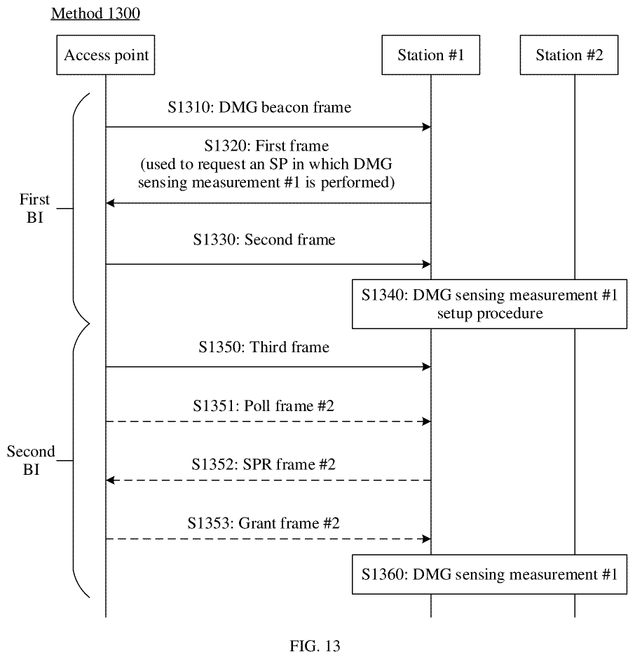

For example, when the access point supports allocating, to the station, the SP in which DMG sensing measurement #1 is performed, after the access point transmits the second frame to the station, the access point may transmit a grant frame to the station in the first BI, where the grant frame is used to allocate the first SP to the station; and/or the access point may transmit a third frame to the station in a second BI, where the third frame is used to allocate, to the station, a second SP in which DMG sensing measurement #1 is performed in the second BI. The following describes, with reference to FIG. 10, a manner in which the access point allocates the first SP to the station through the grant frame, and describes, with reference to FIG. 13, a manner in which the access point allocates the second SP to the station through the third frame.

In a possible implementation, after the access point receives the first frame from the station, if the access point cannot satisfy some requests of the station, for example, the station requests the SP in the first BI but the access point cannot allocate the SP in the first BI to the station, the second frame transmitted by the access point to the station indicates that the access point does not support allocating, to the station, the SP in which DMG sensing measurement #1 is performed, and the second frame indicates a parameter of an SP that is suggested by the access point and in which DMG sensing measurement #1 is performed. For example, the second frame includes a status code, and the status code is set to “REJECTED_WITH_SUGGESTED_CHANGES”, to indicate that the access point temporarily rejects a request of the station, but provides a suggested parameter.

When the second frame indicates the parameter of the SP that is suggested by the access point and in which DMG sensing measurement #1 is performed, the second frame may include information #7, the information #7 indicates the parameter of the SP that is suggested by the access point and in which DMG sensing measurement #1 is performed, and the information #7 is carried in a fourth element included in the second frame. A structure of the fourth element is shown in FIG. 6 or FIG. 8. For more descriptions of the fourth element, refer to the foregoing descriptions of the first element. For example, the fourth element may be named as a DMG TSPEC element.

For example, when the second frame received by the station indicates the parameter of the SP that is suggested by the access point and in which DMG sensing measurement #1 is performed, the station may transmit a fourth frame to the access point based on the parameter of the SP that is suggested by the access point and in which DMG sensing measurement #1 is performed, where the fourth frame is used to request the SP in which DMG sensing measurement #1 is performed. For more descriptions of the fourth frame, refer to the foregoing related descriptions of the first frame.

In a possible implementation, after the access point receives the first frame from the station, if the access point cannot allocate, to the station, the SP in which DMG sensing measurement #1 is performed, the second frame transmitted by the access point to the station indicates that the access point does not support allocating, to the station, the SP in which DMG sensing measurement #1 is performed. For example, the second frame includes a status code, and the status code is set to “REQUEST_DECLINED”, to indicate that the access point does not support allocating, to the station, the SP in which DMG sensing measurement #1 is performed.

For example, when the second frame received by the station indicates that the access point does not support allocating, to the station, the SP in which DMG sensing measurement #1 is performed, the station may preempt a TXOP through channel contention in a CBAP in the first BI and/or a CBAP in a BI after the first BI, and perform DMG sensing measurement #1 after preempting the TXOP. Alternatively, after adjusting the parameter of the SP in which DMG sensing measurement #1 is performed, the station transmits a fourth frame to the access point based on the adjusted parameter, where the fourth frame is used to request the SP in which DMG sensing measurement #1 is performed. For more descriptions of the fourth frame, refer to the foregoing related descriptions of the first frame.

The second frame is not limited in this embodiment of this disclosure.

In a possible implementation, if the first frame is a DMG ADDTS request frame, the second frame may be a DMG ADDTS response frame.

In a possible implementation, if the first frame is a DMG sensing SP request frame, the second frame may be a DMG sensing SP response frame. A DMG action field value corresponding to the DMG sensing SP request frame is ((last assigned)+1) or (last assigned+2). Optionally, a frame format of the DMG sensing SP response frame is shown in Table 2.

TABLE 2
Frame format of a DMG sensing SP response frame
Action field in the DMG sensing SP response frame

| Order | Information |
|---|---|
| 1 | Category |
| 2 | Action |
| 3 | Dialog token |
| 4 | Status code |
| 5 | DMG TSPEC element |

It should be noted that, if the status code included in the DMG sensing SP response frame is set to “REQUEST_DECLINED”, the DMG sensing SP response frame does not include a DMG TSPEC element; or if the status code included in the DMG sensing SP response frame is set to “SUCCESS” or “REJECTED_WITH_SUGGESTED_CHANGES”, the DMG sensing SP response frame may include a DMG TSPEC element.

In a possible implementation, if the first frame is a DMG sensing measurement setup request frame, the second frame is a DMG sensing measurement setup response frame.

As described above, when the first frame is the DMG sensing measurement setup request frame, the first frame may be further used to configure the DMG sensing measurement parameter used to perform DMG sensing measurement #1. In this case, the second frame may further indicate whether the access point supports the DMG sensing measurement parameter.

For example, the second frame indicates that the access point supports allocating, to the station, the SP in which DMG sensing measurement #1 is performed, and supports the DMG sensing measurement parameter used to perform DMG sensing measurement #1. For example, the second frame includes a status code, and the status code is set to “SUCCESS”, to indicate that the access point supports allocating, to the station, the SP in which DMG sensing measurement #1 is performed and supports the sensing measurement parameter used to perform DMG sensing measurement #1.

For another example, the second frame indicates that the access point supports allocating, to the station, the SP in which DMG sensing measurement #1 is performed, and indicates that the access point does not support the DMG sensing measurement parameter used to perform DMG sensing measurement #1. For example, the second frame includes a status code, and the status code is set to “REQUEST_DECLINED_FOR_SENSE_SETUP”, to indicate that the access point supports allocating, to the station, the SP in which DMG sensing measurement #1 is performed, but does not support the sensing measurement parameter used to perform DMG sensing measurement #1.

For another example, the second frame indicates that the access point does not support allocating, to the station, the SP in which DMG sensing measurement #1 is performed, and indicates that the access point supports the DMG sensing measurement parameter used to perform DMG sensing measurement #1. For example, the second frame includes a status code, and the status code is set to “REQUEST_DECLINED_FOR_ALLOCATION”, to indicate that the access point does not support allocating, to the station, the SP in which DMG sensing measurement #1 is performed, but supports the sensing measurement parameter used to perform DMG sensing measurement #1.

For another example, the second frame indicates that the access point does not support allocating, to the station, the SP in which DMG sensing measurement #1 is performed, and indicates that the access point does not support the DMG sensing measurement parameter used to perform DMG sensing measurement #1. For example, the second frame includes a status code, and the status code is set to “REQUEST_DECLINED”, to indicate that the access point does not support allocating, to the station, the SP in which DMG sensing measurement #1 is performed, and does not support the sensing measurement parameter used to perform DMG sensing measurement #1.

For another example, the second frame indicates that the access point supports allocating, to the station, the SP in which DMG sensing measurement #1 is performed, and does not support the DMG sensing measurement parameter used to perform DMG sensing measurement #1, and the second frame indicates a sensing measurement parameter suggested by the access point for performing DMG sensing measurement #1. For example, the second frame includes a status code and the suggested sensing measurement parameter used to perform DMG sensing measurement #1, and the status code is set to “REJECTED_WITH_SUGGESTED_CHANGES”, to indicate that the access point supports allocating, to the station, the SP in which DMG sensing measurement #1 is performed, and indicate that the access point temporarily rejects a sensing measurement parameter configured by the station, but provides the suggested sensing measurement parameter.

For another example, the second frame indicates that the access point does not support allocating, to the station, the SP in which DMG sensing measurement #1 is performed and supports the DMG sensing measurement parameter used to perform DMG sensing measurement #1, and indicates a parameter of an SP that is suggested by the access point and in which DMG sensing measurement #1 is performed. For example, the second frame includes a status code and the parameter of the suggested SP in which DMG sensing measurement #1 is performed, and the status code is set to “REJECTED_WITH_SUGGESTED_CHANGES”, to indicate that the access point supports the sensing measurement parameter used to perform DMG sensing measurement #1, and indicate that the access point temporarily rejects an SP requested by the station, but provides the suggested SP parameter.

For another example, the second frame indicates that the access point does not support allocating, to the station, the SP in which DMG sensing measurement #1 is performed, and does not support the DMG sensing measurement parameter used to perform DMG sensing measurement #1, and the second frame indicates a parameter of an SP that is suggested by the access point and in which DMG sensing measurement #1 is performed and a sensing measurement parameter suggested by the access point for performing DMG sensing measurement #1. For example, the second frame includes a status code, the parameter of the suggested SP in which DMG sensing measurement #1 is performed, and the suggested sensing measurement parameter, and the status code is set to “REJECTED_WITH_SUGGESTED_CHANGES”, to indicate that the access point temporarily rejects an SP requested by the station and a configured sensing measurement parameter, but provides the parameter of the suggested SP and the suggested sensing measurement parameter.

In a possible implementation, if the first frame is a DMG SBP request frame, the second frame is a DMG SBP response frame.

As described above, when the first frame is the DMG SBP request frame, the first frame may be further used to configure the DMG sensing measurement parameter used to perform DMG sensing measurement #1, and the parameter related to the sensing by proxy procedure. In this case, the second frame may be further used to indicate whether the access point supports the DMG sensing measurement parameter, and indicate whether the access point supports the parameter related to the sensing by proxy procedure.

For example, the second frame indicates that the access point supports allocating, to the station, the SP in which DMG sensing measurement #1 is performed, and supports the DMG sensing measurement parameter used to perform DMG sensing measurement #1 and the parameter related to the sensing by proxy procedure. For example, the second frame includes a status code, and the status code is set to “SUCCESS”, to indicate that the access point supports allocating, to the station, the SP in which DMG sensing measurement #1 is performed, and supports the sensing measurement parameter used to perform DMG sensing measurement #1 and the parameter related to the sensing by proxy procedure.

For another example, the second frame indicates that the access point supports allocating, to the station, the SP in which DMG sensing measurement #1 is performed, and indicates that the access point does not support the DMG sensing measurement parameter used to perform DMG sensing measurement #1 and/or the parameter related to the sensing by proxy procedure. For example, the second frame includes a status code, and the status code is set to “REQUEST_DECLINED_FOR_SENSE_SETUP”, to indicate that the access point supports allocating, to the station, the SP in which DMG sensing measurement #1 is performed, but does not support the sensing measurement parameter used to perform DMG sensing measurement #1 and/or the parameter related to the sensing by proxy procedure.

For another example, the second frame indicates that the access point does not support allocating, to the station, the SP in which DMG sensing measurement #1 is performed, and indicates that the access point supports the DMG sensing measurement parameter used to perform DMG sensing measurement #1 and the parameter related to the sensing by proxy procedure. For example, the second frame includes a status code, and the status code is set to “REQUEST_DECLINED_FOR_ALLOCATION”, to indicate that the access point does not support allocating, to the station, the SP in which DMG sensing measurement #1 is performed, but supports the sensing measurement parameter used to perform DMG sensing measurement #1 and the parameter related to the sensing by proxy procedure.

For another example, the second frame indicates that the access point does not support allocating, to the station, the SP in which DMG sensing measurement #1 is performed, and indicates that the access point does not support the DMG sensing measurement parameter used to perform DMG sensing measurement #1 and the parameter related to the sensing by proxy procedure. For example, the second frame includes a status code, and the status code is set to “REQUEST_DECLINED”, to indicate that the access point does not support allocating, to the station, the SP in which DMG sensing measurement #1 is performed, and does not support the sensing measurement parameter used to perform DMG sensing measurement #1 and the parameter related to the sensing by proxy procedure.

For another example, the second frame indicates that the access point supports allocating, to the station, the SP in which DMG sensing measurement #1 is performed, and does not support the DMG sensing measurement parameter used to perform DMG sensing measurement #1 and/or the parameter related to the sensing by proxy procedure, and the second frame indicates a sensing measurement parameter suggested by the access point for performing DMG sensing measurement #1 and/or a parameter that is related to the sensing by proxy procedure and that is suggested by the access point for performing DMG sensing measurement #1. For example, the second frame includes a status code and the suggested sensing measurement parameter used to perform DMG sensing measurement #1 and/or the suggested parameter that is related to the sensing by proxy procedure and that is used to perform DMG sensing measurement #1, and the status code is set to “REJECTED_WITH_SUGGESTED_CHANGES”, to indicate that the access point supports allocating, to the station, the SP in which DMG sensing measurement #1 is performed, and indicate that the access point temporarily rejects a sensing measurement parameter configured by the station, but provides the suggested sensing measurement parameter and/or the suggested parameter related to the sensing by proxy procedure.

For another example, the second frame indicates that the access point does not support allocating, to the station, the SP in which DMG sensing measurement #1 is performed, and supports the DMG sensing measurement parameter used to perform DMG sensing measurement #1 and/or the parameter related to the sensing by proxy procedure, and indicates a parameter of an SP that is suggested by the access point and in which DMG sensing measurement #1 is performed. For example, the second frame includes a status code and the parameter of the suggested SP in which DMG sensing measurement #1 is performed, and the status code is set to “REJECTED_WITH_SUGGESTED_CHANGES”, to indicate that the access point supports the sensing measurement parameter used to perform DMG sensing measurement #1 and/or the parameter related to the sensing by proxy procedure, and indicate that the access point temporarily rejects an SP requested by the station but provides the parameter of the suggested SP.

For another example, the second frame indicates that the access point does not support allocating, to the station, the SP in which DMG sensing measurement #1 is performed, and does not support the DMG sensing measurement parameter used to perform DMG sensing measurement #1 and/or the parameter related to the sensing by proxy procedure, and indicates a parameter of an SP that is suggested by the access point and in which DMG sensing measurement #1 is performed, a sensing measurement parameter suggested by the access point for performing DMG sensing measurement #1, and/or a parameter that is related to the sensing by proxy procedure and that is suggested by the access point for performing DMG sensing measurement #1. For example, the second frame includes a status code, the parameter of the suggested SP in which DMG sensing measurement #1 is performed, the suggested sensing measurement parameter used to perform DMG sensing measurement #1, and/or the suggested parameter that is related to the sensing by proxy procedure and that is used to perform DMG sensing measurement #1, and the status code is set to “REJECTED_WITH_SUGGESTED_CHANGES”, to indicate that the access point temporarily rejects an SP requested by the station and a configured sensing measurement parameter, but provides the parameter of the suggested SP, the suggested sensing measurement parameter, and/or the suggested parameter related to the sensing by proxy procedure.

In this embodiment of this disclosure, the station transmits, to the access point, the first frame used to request the SP in which DMG sensing measurement is performed, so that the access point determines, based on the first frame, that the station needs to perform DMG sensing measurement. This helps the access point allocate, to the station based on the requirement of the station, the SP in which DMG sensing measurement is performed, thereby helping meet the sensing measurement requirement of the station.

For example, if the station is a sensing initiator of DMG sensing measurement, because the SP allocated by the access point to the station is allocated based on the request of the station, the sensing scheduling parameter determined by the station based on the channel allocation parameter in the BI may meet the sensing measurement requirement of the station.

Based on descriptions of the method 400, the following describes, with reference to FIG. 10, a manner in which the access point allocates the first SP in the first BI to the station.

FIG. 10 is a schematic flowchart of a communication method according to an embodiment of this disclosure. As shown in FIG. 10, a method 1000 may include the following steps.

S1010: The access point transmits the DMG beacon frame.

Correspondingly, a station #1 receives the DMG beacon frame from the access point.

The access point broadcasts the DMG beacon frame in the BTI in the BHI included in the first BI, where the DMG beacon frame is used to notify another device of a channel access manner of the DTI in the first BI.

S1020: The station #1 transmits the first frame to the access point.

Correspondingly, the access point receives the first frame from the station #1.

The station #1 transmits the first frame to the access point in the first BI, where the first frame is used to request the SP in which DMG sensing measurement #1 is performed. For example, a sensing initiator of DMG sensing measurement #1 is the station #1, and a sensing responder of DMG sensing measurement #1 is a station #2.

When the station #1 determines, based on the DMG beacon frame, that the first BI includes a dynamic SP, the first frame transmitted by the station #1 to the access point includes the first information, and the first information indicates that DMG sensing measurement #1 is applied in the first BI, or the first information indicates that the station #1 requests an SP or a channel allocation in the first BI, or the first information indicates that DMG sensing measurement #1 starts from the first BI.

For more descriptions of S1020, refer to S410 in the foregoing method 400.

S1030: The access point transmits the second frame to the station #1.

Correspondingly, the station #1 receives the second frame from the access point.

For more descriptions of S1030, refer to S420 in the foregoing method 400.

S1040: The station #1 and the station #2 perform a DMG sensing measurement #1 setup procedure.

For example, in S1040, the station #1 transmits a DMG sensing measurement setup request frame to the station #2, and correspondingly, the station #2 transmits a DMG sensing measurement setup response frame to the station #1.

It should be noted that the station #1 and the station #2 perform the DMG sensing measurement #1 setup procedure in the first BI. For example, the station #1 and the station #2 may perform the DMG sensing measurement #1 setup procedure in a CBAP #2 in the DTI included in the first BI. It may be understood that when the station #1 and the station #2 obtain a TXOP through contention in the CBAP #2, the station #1 and the station #2 may perform the DMG sensing measurement #1 setup procedure in the CBAP #2. Alternatively, the station #1 and the station #2 may perform the DMG sensing measurement #1 setup procedure in an SP #2 in the DTI included in the first BI. It may be understood that, when the access point allocates the SP #2 to the station #1 and the station #2, the station #1 and the station #2 may perform the DMG sensing measurement #1 setup procedure in the SP #2.

It should be further noted that S1040 may be performed before S1020 and/or S1030, or may be performed after S1020 and/or S1030. This is not limited in this embodiment of this disclosure.

Optionally, if the first frame does not include the third information, or the first frame includes the third information, and the third information indicates that the access point transmits the poll frame to the station before the access point allocates the first SP to the station, the method 1000 further includes S1050 and S1060.

S1050: The access point transmits a poll frame #1 to the station #1.

Correspondingly, the station #1 receives the poll frame #1 from the access point.

For example, the access point transmits the poll frame #1 to the station #1 in the dynamic SP in the DTI included in the first BI.

S1060: The station #1 transmits a service period request (SPR) frame #1 to the access point.

Correspondingly, the access point receives the SPR frame #1 from the station #1.

After the station #1 receives the poll frame #1 from the access point in the dynamic SP, if the station #1 needs to perform DMG sensing measurement #1 in the dynamic SP, the station #1 transmits the SPR frame #1 to the access point in the dynamic SP, where the SPR frame #1 is used to request the SP in which DMG sensing measurement #1 is performed in the first BI.

For example, the SPR frame #1 includes information #8, and the information #8 indicates a parameter of the SP that is requested by the station #1 and in which DMG sensing measurement #1 is performed in the first BI.

FIG. 11 is a diagram of a structure of the SPR frame #1. As shown in FIG. 11, the SPR frame #1 may include the following fields: a frame control field; a duration field that indicates duration of the SP requested by the station #1; a receiver address (RA) field that indicates a receiver address of the SPR frame #1; a transmitter address (TA) field that indicates a transmitter address of the SPR frame #1; a dynamic allocation information (dynamic allocation info) field; a BF control field; and a frame check sequence (FCS) field that indicates a check sequence of the SPR frame #1. A unit of the duration may be second(s), millisecond (ms), BI, or the like. This is not limited in this embodiment of this disclosure.

As shown in FIG. 11, the dynamic allocation information field included in the SPR frame #1 may include the following fields: an allocation identifier field that indicates an identifier of an allocation requested by the station #1; an allocation type field that indicates a type of the allocation requested by the station #1; a source AID field that indicates a sensing initiator that performs DMG sensing measurement #1 in the SP requested by the station, that is, indicates the station #1; a destination AID address that indicates a sensing responder that performs DMG sensing measurement #1 in the SP requested by the station, that is, indicates the station #2; an allocation duration field that indicates the duration of the SP requested by the station #1; and a reserved field. A unit of the duration may be second(s), millisecond (ms), BI, or the like. This is not limited in this embodiment of this disclosure.

Optionally, the allocation identifier field is located in a B0 field to a B3 field in the dynamic allocation information field, the allocation type field is located in a B4 field to a B6 field in the dynamic allocation information field, the source AID field is located in a B7 field to a B14 field in the dynamic allocation information field, the destination AID field is located in a B15 field to a B22 field in the dynamic allocation information field, the allocation duration field is located in a B23 field to a B38 field in the dynamic allocation information field, and the reserved field is located in a B39 field in the dynamic allocation information field.

Based on the diagram of the structure of the SPR frame #1 shown in FIG. 11, the information #8 may be located in the allocation duration field included in the SPR frame #1.

It should be noted that, when the first element included in the first frame includes the minimum duration field, a value of the allocation duration field included in the SPR frame #1 is the same as or greater than a value of the minimum duration field.

Optionally, when the first frame includes the first allocation identifier, the SPR frame #1 includes a third allocation identifier, the third allocation identifier corresponds to the SP in which DMG sensing measurement #1 is performed, and the third allocation identifier is the same as the first allocation identifier. For example, the third allocation identifier is carried in the allocation identifier field in the dynamic allocation information field included in the SPR frame #1. The allocation identifier field in the dynamic allocation information field may be located in the B0 field to the B3 field in the dynamic allocation information field.

It may be understood that, when the SPR frame #1 includes the third allocation identifier, and the access point determines that the third allocation identifier is the same as the first allocation identifier, the access point determines that the SPR frame #1 is used to request the SP in which DMG sensing measurement #1 is performed in the first BI.

S1070: The access point transmits a grant frame #1 to the station #1.

Correspondingly, the station #1 receives the grant frame #1 from the access point.

The station #1 receives the grant frame #1 from the access point in the dynamic SP, where the grant frame #1 is used to allocate a first SP to the station #1, and the first SP is in the first BI. Specifically, the first SP is in the dynamic SP included in the first BI. It should be understood that if the access point receives the SPR frame #1 from the station #1, the access point transmits the grant frame #1 to the station #1 based on the SPR frame #1. If the access point does not receive the SPR frame #1 from the station #1, the access point transmits the grant frame #1 to the station #1 based on the first frame.

For example, the grant frame #1 includes information #9, and the information #9 indicates a parameter of the first SP allocated by the access point to the station #1. For example, the information #9 is carried in an allocation duration field included in the grant frame #1, and a structure of the grant frame #1 is shown in FIG. 11.

Optionally, when the first frame includes the first allocation identifier, the grant frame #1 includes a second allocation identifier, the second allocation identifier corresponds to the SP in which DMG sensing measurement #1 is performed, and the second allocation identifier is the same as the first allocation identifier. For example, the second allocation identifier is carried in an allocation identifier field in a dynamic allocation information field included in the grant frame #1. The allocation identifier field in the dynamic allocation information field may be located in a B0 field to a B3 field in the dynamic allocation information field.

It may be understood that, when the grant frame #1 includes the second allocation identifier, and the station #1 determines that the second allocation identifier is the same as the first allocation identifier, the station #1 determines that the first SP allocated by using the grant frame #1 is an SP in which DMG sensing measurement #1 is performed.

S1080: The station #1 and the station #2 perform DMG sensing measurement #1.

In S1080, the station #1 and the station #2 perform DMG sensing measurement #1 in the first SP.

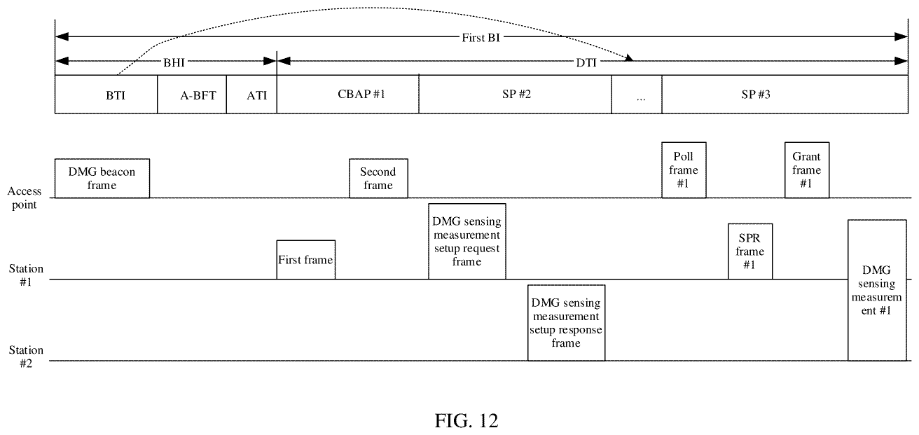

For ease of understanding the method 1000, FIG. 12 shows a sequence of the steps of the method 1000 on a time axis. As shown in FIG. 12, the access point transmits the DMG beacon frame in the BTI included in the first BI. When preempting a TXOP in a CBAP #1, the station #1 transmits the first frame to the access point. Correspondingly, after receiving the first frame in the CBAP #1, the access point may transmit the second frame to the station #1 in the CBAP #1. Further, when the access point allocates an SP #2 to the station #1 and the station #2, the station #1 transmits the DMG sensing measurement setup request frame to the station #2 in the SP #2. Correspondingly, the station #2 transmits the DMG sensing measurement setup response frame to the station #1 in the SP #2. Further, the access point transmits the poll frame #1 to the station #1 in an SP #3. Correspondingly, the station #1 transmits the SPR frame #1 to the access point in the SP #3, and the access point transmits the grant frame #1 to the station #1 in the SP #3 based on the SPR frame #1, where the SP #3 is a dynamic SP. After receiving the grant frame #1, the station #1 performs DMG sensing measurement #1 with the station #2 in the SP #3.

It should be noted that the method 1000 is described by using an example in which a sensing initiator of DMG sensing measurement #1 is the station #1. This is not limited in this embodiment of this disclosure. The sensing initiator of DMG sensing measurement #1 may alternatively be the access point.

It should be further noted that the method 1000 is described by using an example in which a sensing responder of DMG sensing measurement #1 is the station #2. This is not limited in this embodiment of this disclosure. The sensing responder of DMG sensing measurement #1 may be the access point or the station #1.

It should be further noted that, when both the sensing initiator and the sensing responder of DMG sensing measurement #1 are the station #1, a source AID corresponding to the first SP and a destination AID corresponding to the first SP are the same, that is, both the source AID and the destination AID indicate the station #1.

In this embodiment of this disclosure, if the station determines, based on the received DMG beacon frame, that there is a dynamic SP in a current BI, the station may transmit the first frame to the access point, to request the access point to allocate, to the station, an SP in which DMG sensing measurement is performed in the current BI, so that the access point can allocate the SP in the current BI to the station based on the request of the station, and the station performs DMG sensing measurement in the current BI in time, thereby helping meet a DMG sensing measurement requirement of the station.

In addition, if a parameter of the SP in which DMG sensing measurement is performed may need to be updated after the station transmits the first frame to the access point, the first frame transmitted by the station to the access point may include the third information, to indicate the access point to transmit the poll frame to the station before the access point allocates the SP in the current BI to the station, so that the station may update, by transmitting the SPR frame to the access point, the parameter of the SP in which DMG sensing measurement is performed.

FIG. 13 is a schematic flowchart of a communication method according to an embodiment of this disclosure. As shown in FIG. 13, a method 1300 may include the following steps:

S1310: The access point transmits the DMG beacon frame.

Correspondingly, a station #1 receives the DMG beacon frame from the access point.

The access point broadcasts the DMG beacon frame in the BTI in the BHI included in the first BI, where the DMG beacon frame is used to notify another device of a channel access manner of a DTI in the first BI.

S1320: The station #1 transmits the first frame to the access point.

Correspondingly, the access point receives the first frame from the station #1.

The first frame is used to request an SP or a channel allocation used to perform DMG sensing measurement #1. For example, the SP requested by the first frame is a periodic SP or an aperiodic SP.

For more descriptions of S1320, refer to S410 in the foregoing method 400.

S1330: The access point transmits the second frame to the station #1.

Correspondingly, the station #1 receives the second frame from the access point.

For more descriptions of S1330, refer to S420 in the foregoing method 400.

S1340: The station #1 and a station #2 perform a DMG sensing measurement #1 setup procedure.

For more descriptions of S1340, refer to S1040 in the foregoing method 1000.

S1350: The access point transmits the third frame to the station #1.

Correspondingly, the station #1 receives the third frame from the access point.

For example, the access point transmits the third frame to the station #1 in a second BI, where the second BI is after the first BI, the third frame is used to allocate, to the station #1, a second SP in which DMG sensing measurement #1 is performed in the second BI, a source AID corresponding to the second SP identifies a sensing initiator of DMG sensing measurement #1, and a destination AID corresponding to the second SP identifies a sensing responder of DMG sensing measurement #1.

For example, the third frame is a DMG beacon frame. An extended schedule element included in the third frame indicates the second SP allocated by the access point to the station #1.

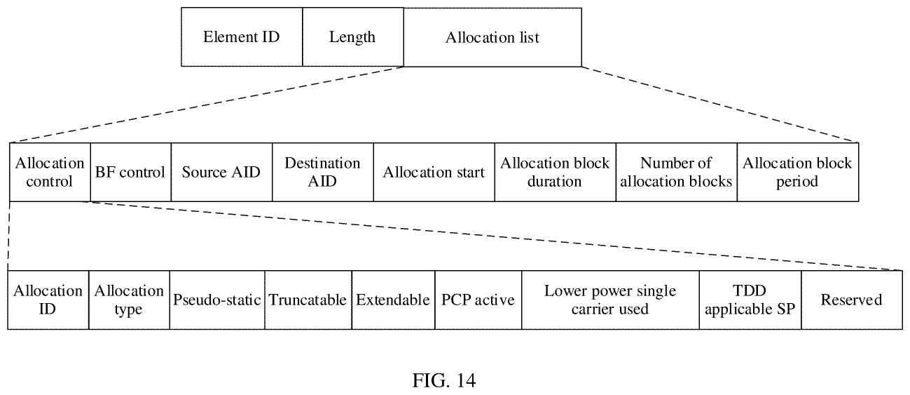

FIG. 14 is a diagram of a structure of the extended schedule element. As shown in FIG. 14, the extended schedule element may include the following fields: an element ID field that indicates an identifier of the extended schedule element; a length field that indicates a length of the extended schedule element; and an allocation list field.

The allocation list field includes one or more allocation fields, the one or more allocation fields include an allocation field corresponding to the second SP, and the allocation field corresponding to the second SP indicates a parameter of the second SP. As shown in FIG. 14, the allocation field corresponding to the second SP may include the following fields: an allocation control field; a BF control field that indicates control information related to beamforming; a source AID field that indicates the sensing initiator of DMG sensing measurement #1; a destination AID address that indicates the sensing responder of DMG sensing measurement #1; an allocation start field that indicates a start moment of the second SP; an allocation block duration field that indicates duration of the second SP; a number of allocation blocks (number of blocks) field that indicates a number of SPs included in channel allocation duration; and an allocation block period field that indicates a time interval between two consecutive SPs included in a same channel allocation. A unit of the duration or the time interval may be second(s), millisecond (ms), BI, or the like. This is not limited in this embodiment of this disclosure.

As shown in FIG. 14, the allocation control field included in the allocation field corresponding to the second SP may include the following fields: an allocation identifier field that indicates an allocation identifier corresponding to the second SP; an allocation type field that indicates a type of the second SP, where when the field is set to “001”, it indicates that the second SP is an SP in which DMG sensing measurement is performed; a pseudo-static field that indicates whether the second SP is quasi-static; a truncatable field that indicates whether the second SP is truncatable; an extendable field that indicates whether the second SP is extendable; a PCP active field that indicates whether to enable PCP; a lower power (LP) single carrier (SC) used (LP SC used) field that indicates whether to use a lower power single carrier; a TDD applicable SP that indicates whether to use TDD for the second SP; and a reserved field. A quasi-static SP means that start time of the SP in each BI is fixed relative to start time of the BI. The start time of the BI may be referred to as TBTT.

With reference to the foregoing descriptions of the method 400, if the first frame includes the second information, the allocation field corresponding to the second SP includes the allocation block period field. In this case, the time interval indicated by the allocation block period field is not greater than a maximum interval between two consecutive SPs that is indicated by the second information and in which DMG sensing measurement #1 is performed.

Optionally, when the first frame includes the first allocation identifier, the third frame includes a fourth allocation identifier, the fourth allocation identifier corresponds to the SP in which DMG sensing measurement #1 is performed, and the fourth allocation identifier is the same as the first allocation identifier. For example, the fourth allocation identifier is carried in the extended schedule element included in the third frame and the allocation field corresponding to the second SP. Specifically, the fourth allocation identifier is carried in the allocation identifier field in the allocation control field included in the allocation field corresponding to the second SP.

It may be understood that, when the third frame includes the fourth allocation identifier, and the station #1 determines that the fourth allocation identifier is the same as the first allocation identifier, the station #1 determines that the second SP is an SP that is allocated by the access point to the station #1 and in which DMG sensing measurement #1 is performed in the second BI.

Optionally, the SP requested by the first frame is an aperiodic SP, the source AID corresponding to the second SP is not set to an AID of the sensing initiator of DMG sensing measurement #1, and the destination AID corresponding to the second SP is not set to the sensing responder of DMG sensing measurement #1. In this case, the method 1300 further includes S1351 to S1353.

S1351: The access point transmits a poll frame #2 to the station #1.

Correspondingly, the station #1 receives the poll frame #2 from the access point.

The access point transmits the poll frame #2 to the station #1 in the second SP.

S1352: The station #1 transmits an SPR frame #2 to the access point.

Correspondingly, the access point receives the SPR frame #2 from the station #1.

The SPR frame #2 is used to request to perform DMG sensing measurement #1 in the second SP.

The station #1 transmits the SPR frame #2 to the access point in the second SP.

For more descriptions of the SPR frame #2, refer to the descriptions of the SPR frame #1 in S1060 in the foregoing method 1000.

S1353: The access point transmits a grant frame #2 to the station #1.

Correspondingly, the station #1 receives the grant frame #2 from the access point.

The grant frame #2 is used to allocate, to the station #1, an SP in which DMG sensing measurement #1 is performed in the second SP.

The access point transmits the grant frame #2 to the station #1 in the second SP.

For more descriptions of the grant frame #2, refer to the descriptions of the grant frame #1 in S1070 in the foregoing method 1000.

S1360: The station #1 and the station #2 perform DMG sensing measurement #1.

In S1360, the station #1 and the station #2 perform DMG sensing measurement #1 in the second SP.

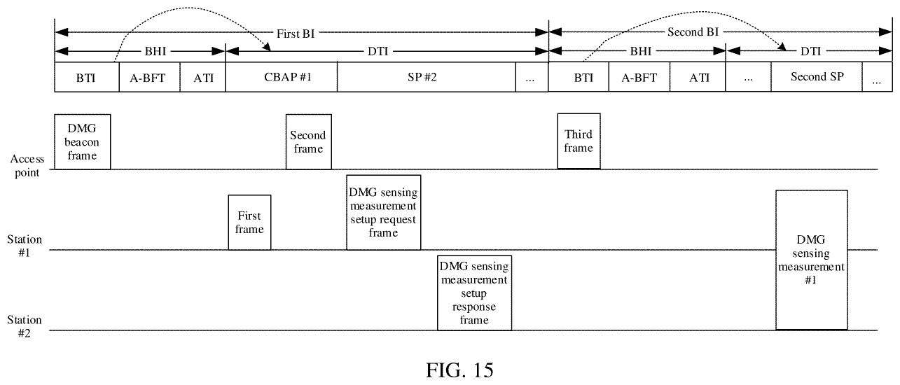

For ease of understanding the method 1300, FIG. 15 shows a sequence of the steps of the method 1300 on a time axis. As shown in FIG. 15, the access point transmits the DMG beacon frame in the BTI included in the first BI. When preempting a TXOP in a CBAP #1, the station #1 transmits the first frame to the access point. Correspondingly, after receiving the first frame in the CBAP #1, the access point may transmit the second frame to the station #1 in the CBAP #1. Further, when the access point allocates an SP #2 to the station #1 and the station #2, the station #1 transmits the DMG sensing measurement setup request frame to the station #2 in the SP #2. Correspondingly, the station #2 transmits the DMG sensing measurement setup response frame to the station #1 in the SP #2. Further, the access point transmits the third frame in the BTI included in the second BI. Correspondingly, after receiving the third frame, the station #1 determines, based on the third frame, that the second SP is an SP that is allocated by the access point to the station #1 and the station #2 and in which DMG sensing measurement #1 is performed. Further, the station #1 performs DMG sensing measurement #1 with the station #2 in the second SP.

It should be noted that the method 1300 is described by using an example in which the sensing initiator of DMG sensing measurement #1 is the station #1. This is not limited in this embodiment of this disclosure. The sensing initiator of DMG sensing measurement #1 may alternatively be the access point.

It should be further noted that the method 1300 is described by using an example in which the sensing responder of DMG sensing measurement #1 is the station #2. This is not limited in this embodiment of this disclosure. The sensing responder of DMG sensing measurement #1 may be the access point or the station #1. When both the sensing initiator and the sensing responder of DMG sensing measurement #1 are the station #1, the source AID corresponding to the second SP and the destination AID corresponding to the second SP are the same, that is, both the source AID and the destination AID indicate the station #1.

In this embodiment of this disclosure, the station may transmit the first frame to the access point in the first BI, to request the access point to allocate, to the station, an SP in which DMG sensing measurement is performed, so that the access point can allocate an SP in the second BI to the station based on the request of the station, and the station performs DMG sensing measurement in the second BI, thereby helping meet a DMG sensing measurement requirement of the station.

It should be understood that, in embodiments of this disclosure, FIG. 4, FIG. 10, and FIG. 13 are merely used as examples to describe the methods provided in embodiments of this disclosure. Sequence numbers of the foregoing processes do not mean execution sequences. Execution sequences of the processes should be determined based on functions and internal logic of the processes, and should not constitute any limitation on implementation processes of embodiments of this disclosure.

It should be further understood that, in some of the foregoing embodiments, a device (for example, a station or an access point) in an existing network architecture is mainly used as an example for description. It should be understood that a specific form of the device is not limited in embodiments of this disclosure. For example, embodiments of this disclosure are applicable to all future devices that can implement a same function.

It may be understood that, in the foregoing method embodiments, methods and operations implemented by a device (for example, the foregoing station or access point) may also be implemented by a component (for example, a chip or a circuit) of the device.

It may be further understood that, to implement the foregoing functions, the station and the access point include a corresponding hardware structure and/or a corresponding software module for performing each function.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

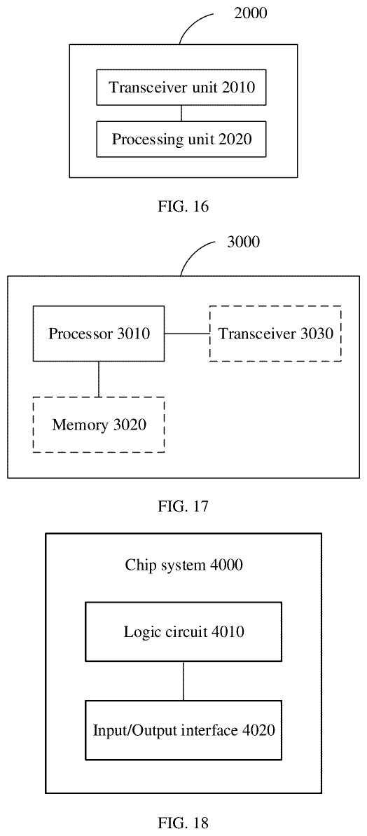

The following describes in detail apparatuses provided in embodiments of this disclosure with reference to FIG. 16 to FIG. 18. It should be understood that descriptions of apparatus embodiments correspond to descriptions of method embodiments. Therefore, for content that is not described in detail, refer to the foregoing method embodiments. For brevity, some content is not described again.

In embodiments of this disclosure, a station or an access point may be divided into functional modules based on the foregoing method embodiments. For example, functional modules may be obtained through division based on corresponding functions, or two or more functions may be integrated into one processing module. The integrated module may be implemented in a form of hardware, or may be implemented in a form of a software functional module. It should be noted that, in embodiments of this disclosure, division into modules is an example, and is merely logical function division. In actual implementation, another division manner may be used. An example in which functional modules are obtained through division based on corresponding functions is used below for description.

FIG. 16 is a block diagram of a communication apparatus according to an embodiment of this disclosure. As shown in FIG. 16, a communication apparatus 2000 may include a transceiver unit 2010 and a processing unit 2020. The transceiver unit 2010 may communicate with the outside, and the processing unit 2020 is configured to process data. The transceiver unit 2010 may also be referred to as a communication interface or a communication unit.

Optionally, the communication apparatus 2000 may further include a storage unit. The storage unit may be configured to store instructions and/or data. The processing unit 2020 may read the instructions and/or the data in the storage unit, to enable the communication apparatus to implement the foregoing method embodiments.

In a first implementation, the communication apparatus 2000 may be the station in the foregoing embodiments, or may be a component (for example, a chip) of the station. The communication apparatus 2000 may implement steps or procedures performed by the station in the foregoing method embodiments. The transceiver unit 2010 may be configured to perform transmitting/receiving-related operations of the station in the foregoing method embodiments, and the processing unit 2020 may be configured to perform processing-related operations of the station in the foregoing method embodiments.

In a possible implementation, the transceiver unit 2010 is configured to transmit a first frame to an access point in a first BI, where the first frame is used to request an SP in which DMG sensing measurement is performed; and the transceiver unit 2010 is further configured to receive a second frame from the access point in the first BI, where the second frame is a response frame of the first frame.

In a second implementation, the communication apparatus 2000 may be the access point in the foregoing embodiments, or may be a component (for example, a chip) of the access point. The communication apparatus 2000 may implement steps or procedures performed by the access point in the foregoing method embodiments. The transceiver unit 2010 may be configured to perform transmitting/receiving-related operations of the access point in the foregoing method embodiments, and the processing unit 2020 may be configured to perform processing-related operations of the access point in the foregoing method embodiments.

In a possible implementation, the transceiver unit 2010 is configured to receive a first frame from a station in a first BI, where the first frame is used to request an SP in which DMG sensing measurement is performed; and the transceiver unit 2010 is further configured to transmit a second frame to the station in the first BI, where the second frame is a response frame of the first frame.

It should be understood that specific processes in which the units perform corresponding steps are described in detail in the foregoing method embodiments. For brevity, details are not described herein again.

It should also be understood that the communication apparatus 2000 herein is presented in a form of a functional unit. The term “unit” herein may be an application-specific integrated circuit (ASIC), an electronic circuit, a processor (such as a shared processor, a dedicated processor, or a group processor) configured to execute one or more software or firmware programs, a memory, a merged logic circuit, and/or another appropriate component that supports the described functions. In an optional example, a person skilled in the art may understand that the communication apparatus 2000 may be specifically the station in the foregoing embodiments, and may be configured to perform procedures and/or steps corresponding to the station in the foregoing method embodiments; or the communication apparatus 2000 may be specifically the access point in the foregoing embodiments, and may be configured to perform procedures and/or steps corresponding to the access point in the foregoing method embodiments. To avoid repetition, details are not described herein again. The transceiver unit 2010 may alternatively be a transceiver circuit (for example, may include a receiving circuit and a transmitting circuit), and the processing unit 2020 may be a processing circuit.

The communication apparatus 2000 in FIG. 16 may be a device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

The communication apparatus 2000 in the foregoing solutions has a function of implementing corresponding steps performed by the station or the access point in the foregoing methods. The function may be implemented by hardware, or may be implemented by hardware executing corresponding software. The hardware or the software includes one or more modules corresponding to the foregoing functions. For example, the transceiver unit may be replaced by a transceiver (for example, a transmitting unit in the transceiver unit may be replaced by a transmitter, and a receiving unit in the transceiver unit may be replaced by a receiver), and another unit, for example, the processing unit, may be replaced by a processor, to separately perform receiving and transmitting operations and a related processing operation in the method embodiments.

FIG. 17 is a diagram of a communication apparatus 3000 according to an embodiment of this disclosure. The communication apparatus 3000 includes a processor 3010. The processor 3010 is configured to execute a computer program or instructions stored in a memory 3020, or read data or signaling stored in the memory 3020, to perform the methods in the foregoing method embodiments. Optionally, there are one or more processors 3010.

Optionally, as shown in FIG. 17, the communication apparatus 3000 further includes the memory 3020. The memory 3020 is configured to store the computer program or the instructions and/or data. The memory 3020 and the processor 3010 may be integrated or disposed separately. Optionally, there are one or more memories 3020.

Optionally, as shown in FIG. 17, the communication apparatus 3000 further includes a transceiver 3030. The transceiver 3030 is configured to receive and/or transmit a signal. For example, the processor 3010 is configured to control the transceiver 3030 to receive and/or transmit the signal.

In a solution, the communication apparatus 3000 is configured to implement operations performed by the station in the foregoing method embodiments.

For example, the processor 3010 is configured to execute the computer program or the instructions stored in the memory 3020, to implement related operations of the station in the foregoing method embodiments, for example, the method performed by the station in the embodiment shown in FIG. 4, FIG. 10, or FIG. 13.

In another solution, the communication apparatus 3000 is configured to implement operations performed by the access point in the foregoing method embodiments.

For example, the processor 3010 is configured to execute the computer program or the instructions stored in the memory 3020, to implement related operations of the access point in the foregoing method embodiments, for example, the method performed by the access point in the embodiment shown in FIG. 4, FIG. 10, or FIG. 13.

It should be understood that, the processor mentioned in this embodiment of this disclosure may be a central processing unit (CPU), and may further be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in this embodiment of this disclosure may be a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM). For example, the RAM may be used as an external cache. By way of example, and not limitation, the RAM includes a plurality of forms, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

It should be noted that when the processor is a general-purpose processor, a DSP, an ASIC, an FPGA or another programmable logic device, a discrete gate or a transistor logic device, or a discrete hardware component, the memory (storage module) may be integrated into the processor.

It should further be noted that the memory described herein is intended to include, but is not limited to, these and any other appropriate type of memory.

FIG. 18 is a diagram of a chip system 4000 according to an embodiment of this disclosure. The chip system 4000 (also referred to as a processing system) includes a logic circuit 4010 and an input/output interface 4020.

The logic circuit 4010 may be a processing circuit in the chip system 4000. The logic circuit 4010 may be coupled and connected to a storage unit, and invoke instructions in the storage unit, to enable the chip system 4000 to implement methods and functions in embodiments of this disclosure. The input/output interface 4020 may be an input/output circuit in the chip system 4000, and output information processed by the chip system 4000, or input to-be-processed data or signaling information into the chip system 4000 for processing.

Specifically, for example, if the chip system 4000 is installed in a station, the logic circuit 4010 is coupled to the input/output interface 4020, the logic circuit 4010 may transmit a first frame through the input/output interface 4020, and the logic circuit 1010 generates the first frame. For another example, if the chip system 4000 is installed in an access point, the logic circuit 4010 is coupled to the input/output interface 4020, the logic circuit 4010 may receive a first frame through the input/output interface 4020, and the logic circuit 4010 parses the first frame.

In a solution, the chip system 4000 is configured to implement operations performed by the station in the foregoing method embodiments.

For example, the logic circuit 4010 is configured to implement processing-related operations performed by the station in the foregoing method embodiments, for example, processing-related operations performed by the station in the embodiment shown in FIG. 4, FIG. 10, or FIG. 13; and the input/output interface 4020 is configured to implement transmitting and/or receiving-related operations performed by the station in the foregoing method embodiments, for example, transmitting and/or receiving-related operations performed by the station in the embodiment shown in FIG. 4, FIG. 10, or FIG. 13.

In another solution, the chip system 4000 is configured to implement operations performed by the access point in the foregoing method embodiments.

For example, the logic circuit 4010 is configured to implement processing-related operations performed by the access point in the foregoing method embodiments, for example, processing-related operations performed by the access point in the embodiment shown in FIG. 4, FIG. 10, or FIG. 13; and the input/output interface 4020 is configured to implement transmitting and/or receiving-related operations performed by the access point in the foregoing method embodiments, for example, transmitting and/or receiving-related operations performed by the access point in the embodiment shown in FIG. 4, FIG. 10, or FIG. 13.

An embodiment of this disclosure further provides a computer-readable storage medium. The computer-readable storage medium stores computer instructions for implementing methods performed by devices in the foregoing method embodiments.

For example, when the computer program is executed by a computer, the computer is enabled to implement the methods performed by the station in the foregoing method embodiments.

For another example, when the computer program is executed by a computer, the computer is enabled to implement the methods performed by the access point in the foregoing method embodiments.

An embodiment of this disclosure further provides a computer program product, including instructions. When the instructions are executed by a computer, methods performed by devices (for example, a station or an access point) in the foregoing method embodiments is implemented.

An embodiment of this disclosure further provides a communication system, including the foregoing station and access point.

For explanations and beneficial effect of related content in any one of the apparatuses provided above, refer to the corresponding method embodiment provided above. Details are not described herein again.

In the several embodiments provided in this disclosure, it should be understood that the disclosed apparatus and method may be implemented in other manners. For example, the described apparatus embodiments are merely examples. For example, division into the units is merely logical function division and may be another division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

All or some of the foregoing embodiments may be implemented by using software, hardware, firmware, or any combination thereof. When the foregoing embodiments are implemented by using software, all or some of the embodiments may be implemented in a form of a computer program product. The computer program product includes one or more computer instructions. When the computer program instructions are loaded and executed on a computer, the procedure or functions according to embodiments of this disclosure are all or partially generated. The computer may be a general-purpose computer, a dedicated computer, a computer network, or another programmable apparatus. For example, the computer may be a personal computer, a server, or a network device. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state drive (SSD)), or the like. For example, the usable medium may include but is not limited to any medium that can store program code, for example, a USB flash drive, a removable hard disk, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A communication method, comprising:
transmitting, by a station, a first frame to an access point in a first beacon interval (BI), wherein the first frame is used to request a service period (SP) in which directional multi-gigabit (DMG) sensing measurement is performed; and
receiving, by the station, a second frame from the access point in the first BI, wherein the second frame is a response frame of the first frame.

2. The communication method according to claim 1, wherein the first frame comprises first information, and the first information indicates whether DMG sensing measurement is applied in the first BI.

3. The communication method according to claim 2, wherein the first information is carried in a DMG allocation information field in a DMG traffic specification (TSPEC) element comprised in the first frame.

4. The communication method according to claim 1, wherein the first frame comprises information, and the information indicates a maximum interval between two consecutive SPs that are requested by the station and in which DMG sensing measurement is performed.

5. The communication method according to claim 4, wherein the information is carried in a DMG traffic specification (TSPEC) element comprised in the first frame.

6. The communication method according to claim 1, wherein the first frame comprises information, the information indicates whether the access point transmits a poll frame to the station before the access point allocates, to the station, a first SP in which DMG sensing measurement is performed, and the first SP is in the first BI.

7. The communication method according to claim 6, wherein the information is carried in a DMG allocation information field in a DMG traffic specification (TSPEC) element comprised in the first frame.

8. The communication method according to claim 1, wherein after the receiving, by the station, of the second frame from the access point, the communication method further comprises:
receiving, by the station, a grant frame from the access point in the first BI, wherein the grant frame is used to allocate, to the station, a first SP in which DMG sensing measurement is performed, and the first SP is in the first BI.

9. The communication method according to claim 8, wherein the first frame comprises a first allocation identifier, and the first allocation identifier corresponds to the SP in which the DMG sensing measurement is performed; and
the grant frame comprises a second allocation identifier, the second allocation identifier corresponds to the SP in which DMG sensing measurement is performed, the second allocation identifier is the same as the first allocation identifier, and the second allocation identifier is carried in a B0 field to a B3 field in a dynamic allocation information field comprised in the grant frame.

10. The communication method according to claim 8, wherein before the receiving, by the station, of the grant frame from the access point in the first BI, the communication method further comprises:
receiving, by the station, a poll frame from the access point in the first BI; and
transmitting, by the station to the access point, a service period request frame in the first BI based on the poll frame, wherein the service period request frame is used to request the SP in which DMG sensing measurement is performed in the first BI, wherein
the grant frame is transmitted by the access point based on the service period request frame.

11. A communication method, comprising:
receiving, by an access point, a first frame from a station in a first beacon interval (BI), wherein the first frame is used to request a service period (SP) in which directional multi-gigabit (DMG) sensing measurement is performed; and
transmitting, by the access point, a second frame to the station in the first BI, wherein the second frame is a response frame of the first frame.

12. The communication method according to claim 11, wherein the first frame comprises first information, and the first information indicates whether DMG sensing measurement is applied in the first BI.

13. The communication method according to claim 12, wherein the first information is carried in a DMG allocation information field in a DMG traffic specification (TSPEC) element comprised in the first frame.

14. The communication method according to claim 11, wherein the first frame comprises information, and the information indicates a maximum interval between two consecutive that are requested by the station and in which DMG sensing measurement is performed.

15. The communication method according to claim 14, wherein the information is carried in a DMG traffic specification (TSPEC) element comprised in the first frame.

16. The communication method according to claim 11, wherein the first frame comprises information, the information indicates whether the access point transmits a poll frame to the station before the access point allocates, to the station, a first SP in which DMG sensing measurement is performed, and the first SP is in the first BI.

17. The communication method according to claim 16, wherein the information is carried in a DMG allocation information field in a DMG traffic specification (TSPEC) element comprised in the first frame.

18. The communication method according to claim 11, wherein after the transmitting, by the access point, of the second frame to the station, the communication method further comprises:
transmitting, by the access point, a grant frame to the station in the first BI, wherein the grant frame is used to allocate, to the station, a first SP in which DMG sensing measurement is performed, and the first SP is in the first BI.

19. The communication method according to claim 18, wherein the first frame comprises a first allocation identifier, and the first allocation identifier corresponds to the SP in which the DMG sensing measurement is performed; and
the grant frame comprises a second allocation identifier, the second allocation identifier corresponds to the SP in which DMG sensing measurement is performed, the second allocation identifier is the same as the first allocation identifier, and the second allocation identifier is carried in a B0 field to a B3 field in a dynamic allocation information field comprised in the grant frame.

20. The communication method according to claim 18, wherein before the transmitting, by the access point, of the grant frame to the station in the first BI, the communication method further comprises:
transmitting, by the access point, a poll frame to the station in the first BI; and
receiving, by the access point, a service period request frame from the station in the first BI, wherein the service period request frame is used to request the SP in which DMG sensing measurement is performed in the first BI, wherein
the grant frame is transmitted by the access point based on the service period request frame.
